(19) United States
(12) Patent Application Publication
(10) Pub. No.: US 2018/0285852 A1
(43) Pub. Date: Oct. 4, 2018

(54) POS SYSTEM, POS DEVICE, DATA PROCESSING METHOD THEREFOR, AND RECORDING MEDIUM

(71) Applicant: NEC Corporation, Minato-ku, Tokyo (JP)

(72) Inventor: Takahiro MATSUI, Tokyo (JP)

(73) Assignee: NEC Corporation, Minato-ku, Tokyo (JP)

(21) Appl. No.: 15/763,572

(22) PCT Filed: Sep. 15, 2016
(86) PCT No.: PCT/JP2016/004207

§ 371 Date: Mar. 27, 2018

(30) Foreign Application Priority Data
Sep. 30, 2015 (JP) 2015-195351

(51) Int. Cl. G06Q 20/20; G06Q 30/06; G07G 1/12

(52) U.S. Cl. CPC G06Q 20/208; G07G 1/12; G06Q 30/0641

(57) ABSTRACT

To provide a POS system, a POS device, a data processing method therefor, and a recording medium, the POS system and the POS device being capable of selecting an advertisement having a high advertising effect and displaying the advertisement on a display, the POS device includes: a product registering unit that registers a product by reading product identification information from the product; and a product displaying unit that displays, based on customer information generated by image-capturing a customer in front of the POS device itself, a product relating to the customer in a selectable manner, the product registering unit adding and registering the product when the product displayed on the product displaying unit is selected.

### TECHNICAL FIELD

The present invention relates to a POS system, a POS device, a data processing method therefor, and a recording medium.

### BACKGROUND ART

One example of a point of sales (POS) system is described in PTL 1. The POS system of PTL 1 includes means which acquires biometric information of a customer, a unit that confirms that the customer is a person him/herself, based on the acquired biometric information, and a management server that manages attribute information of the customer in association with the biometric information, and operates as follows.

After a customer is authenticated as a person him/herself by using biometric information, settlement is made based on attribute information of the customer in a server. Further, advertisement information of a specific product is retrieved from a purchase tendency of the customer and is output to various types of terminals disposed in a store.

Further, it is described that a customer information management system described in PTL 2 determines an attribute of a customer by using a camera attached to a POS terminal and capturing and processing an image of the customer and associate a well-selling product with a purchaser attribute.

A system described in PTL 3 selects a recommended product by using an attribute acquired from a purchase history of a customer and a face image of the customer with respect to net shopping and provides advice to the customer.

A system described in PTL 4 determines a personal feature of a customer as individual information and provides a sales promotion service corresponding to a customer segment based on the individual information. In the system described in the document, marketing information is generated by using a traffic line (a moving path or a staying time) and the like of a customer.

### CITATION LIST

### Patent Literature

[PTL 1] Japanese Laid-open Patent Publication No. 2006-221515

[PTL 2] Japanese Laid-open Patent Publication No. 2002-32553

[PTL 3] Japanese Laid-open Patent Publication No. 2002-92132

[PTL 4] Japanese Laid-open Patent Publication No. 2008-152810

### SUMMARY OF INVENTION

### Technical Problem

However, in the techniques described in the above-described patent literature, the systems are configured to display information of a recommended product on a display installed in a store to a customer in the store, and therefore there is a problem that an advertising effect of an advertisement displayed on the display to an unspecified number of customers is not high.

In view of the circumstance, the present invention has been made, and an object of the present invention is to provide a POS system, a POS device, a data processing method therefor, and a recording medium, the POS system and the POS device being capable of selecting an advertisement having a high advertising effect and displaying the advertisement on a display.

### Solution to Problem

In aspects of the present invention, in order to solve the above described problem, the following constitutions are employed.

A first aspect relates to a POS device.

The POS device according to the first aspect includes:

a product registering means which registers a product by reading product identification information from the product; and

a first displaying means which displays, based on customer information generated by image-capturing a customer in front of the POS device itself, a product relating to the customer in a selectable manner,

the product registering means adding and registering the product when the product displayed on the first displaying means is selected.

A second aspect relates to a data processing method executed by at least one computer.

The data processing method according to the second aspect includes: by using a POS device,

registering a product by reading product identification information from the product;

displaying, based on customer information generated by image-capturing a customer in front of the POS device itself, a product relating to the customer in a selectable manner; and

adding and registering the product when the displayed product is selected.

Another aspect of the present invention may be a program that causes at least one computer to execute the method of the second aspect or may be a computer-readable recording medium recording such a program. The recording medium includes a non-transitory, tangible medium.

The computer program includes, when being executed by a computer, a computer program code that causes the computer to execute the data processing method on a settlement processing device.

Any combination of the above-described components and any matter obtained by converting an expression of the present invention among a method, a device, a system, a recording medium, a computer program and the like is also effective as a form of the present invention.

Further, various types of components of the present invention do not always need to exist independently of each other, and, for example, a plurality of components may be formed as one member, one component may be formed with a plurality of members, a certain component may be a part of another component, or a part of a certain component and a part of another component may be overlapped.

Further, in the method and the computer program of the present invention, a plurality of steps is described in order, but the described order does not limit an order of execution of the plurality of steps. Therefore, when the method and the computer program of the present invention are executed, the order of the plurality of steps can be modified within a range where a disadvantage in a content is not produced.

Further, a plurality of steps of the method and the computer program of the present invention is not limited to execution at timings individually different from each other. Therefore, for example, during execution of a certain step, another step may occur, or an execution timing of a certain step and a part or the whole of an execution timing of another step may be overlapped.

### Advantageous Effects of Invention

According to the aspects, it is possible to provide a POS system, a POS device, a data processing method therefor, and a recording medium, the POS system and the POS device being capable of selecting an advertisement having a high advertising effect and displaying the selected advertisement on a display.

### BRIEF DESCRIPTION OF DRAWINGS

FIG. 1 is a function block diagram logically illustrating a configuration of a settlement processing device according to an example embodiment of the present invention.

FIG. 2 is a diagram illustrating one example of a conceptual configuration of a settlement processing system according to an example embodiment of the present embodiment.

FIG. 3 is a diagram illustrating one example of a configuration of a computer that achieves a server device of the present example embodiment.

FIG. 4 is a perspective view illustrating an external appearance of a register terminal that achieves the settlement processing device of the present example embodiment.

FIG. 5 is a diagram for illustrating a view angle of a display and an imaging range of a camera of the register terminal that achieves the settlement processing device of the present example embodiment.

FIG. 6 is a diagram illustrating one example of a configuration of a computer that achieves the register terminal of FIG. 4.

FIG. 7 is a diagram illustrating an example of a structure of a database of the settlement processing device of the present example embodiment.

FIG. 8 is a diagram illustrating an example of a structure of a database of the settlement processing device of the present example embodiment.

FIG. 9 is a diagram illustrating an example of a screen displayed by a product displaying unit of the settlement processing device of the present example embodiment.

FIG. 10 is a flowchart illustrating one example of an operation of the settlement processing device of the present example embodiment.

FIG. 11 is a diagram illustrating one example of settlement information generated by a product registering unit of the settlement processing device of the present example embodiment.

FIG. 12 is a function block diagram logically illustrating a configuration of a settlement processing device according to an example embodiment of the present invention.

FIG. 13 is a diagram illustrating one example of a screen of an additional purchase product list displayed on a customer display of the register terminal of the present example embodiment.

FIG. 14 is a flowchart illustrating one example of an operation of the settlement processing device of the present example embodiment.

FIG. 15 is a function block diagram logically illustrating a configuration of a settlement processing device according to an example embodiment of the present invention.

FIG. 16 is a diagram illustrating one example of a screen displayed by a product location displaying unit of the settlement processing device of the present example embodiment.

FIG. 17 is a flowchart illustrating one example of an operation of the settlement processing device of the present example embodiment.

FIG. 18 is a function block diagram logically illustrating a configuration of a settlement processing device according to an example embodiment of the present invention.

FIG. 19 is a diagram illustrating one example of a structure of a member information storage unit of the settlement processing device of the present example embodiment.

FIG. 20 is a diagram illustrating one example of a structure of a delivery list and a delivery destination information list included in a database of the settlement processing device of the present example embodiment.

FIG. 21 is a diagram illustrating an example of an order screen displayed by an order screen displaying unit of the settlement processing device of the present example embodiment.

FIG. 22 is a flowchart illustrating one example of an operation of the settlement processing device of the present example embodiment.

FIG. 23 is a flowchart illustrating one example of an operation of a settlement processing device of an example of the present invention.

FIG. 24 is a flowchart illustrating one example of an operation of a settlement processing device of an example of the present invention.

FIG. 25 is a flowchart illustrating one example of an operation of a settlement processing device of an example of the present invention.

FIG. 26 is a flowchart illustrating one example of an operation of a settlement processing device of an example of the present invention.

FIG. 27 is a function block diagram logically illustrating a configuration of a POS device according to an example embodiment of the present invention.

FIG. 28 is a flowchart illustrating one example of an operation of the POS device of the present example embodiment.

### EXAMPLE EMBODIMENT

Hereinafter, example embodiments of the present invention will be described using the accompanying drawings. In all the drawings, a similar component is assigned with a similar reference sign and description thereof will be omitted, as appropriate.

### First Example Embodiment

A POS device, a data processing method therefor, and a program according to a first example embodiment of the present invention will be described.

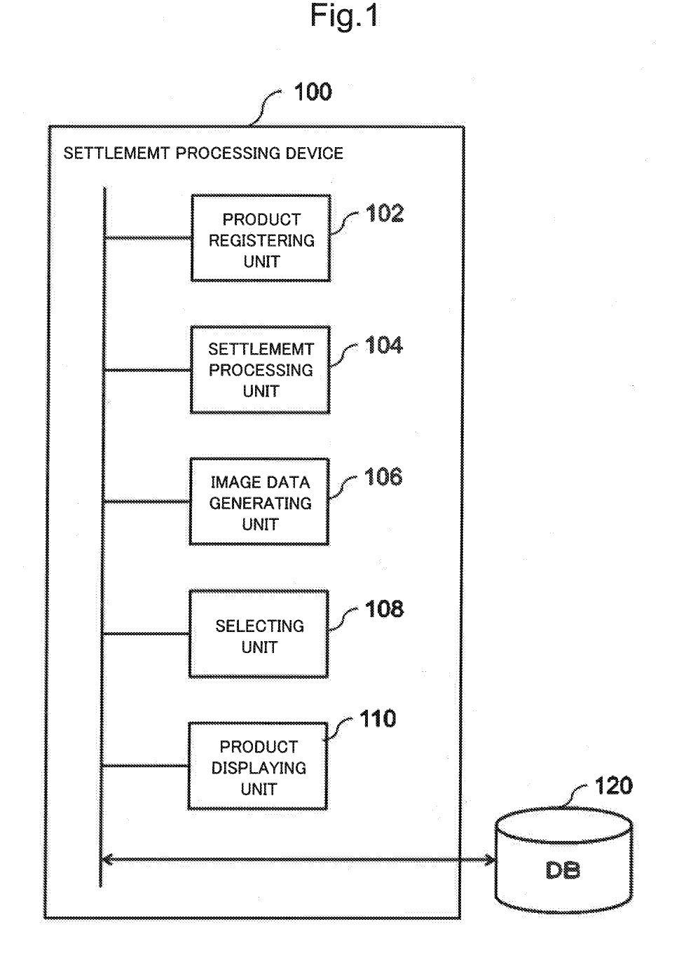

FIG. 1 is a function block diagram logically illustrating a configuration of a settlement processing device 100 according to an example embodiment of the present invention. In the present invention, an information processing device is, for example, a point of sales (POS) device.

The settlement processing device 100 of the present example embodiment includes a product registering unit 102 that registers a product by reading product identification information (hereinafter, referred to also as a “product ID”) from the product, a settlement processing unit 104 that executes settlement processing for the product registered by the product registering unit 102, an image data generating unit 106 that generates image data by image-capturing a customer in front of the settlement processing device 100, a selecting unit 108 that selects a product to be recommended to the customer by using the image data, and a product displaying unit 110 that displays the product selected by the selecting unit 108 to the customer in a selectable manner after the settlement processing by the settlement processing unit 104 or the product registration processing by the product registering unit 102 is started.

Further, the settlement processing device 100 is accessibly connected to a database 120. The database 120 may be included in the settlement processing device 100 or may be included in an external device different from the settlement processing device 100 or a recording medium. Details of the database 120 will be described later.

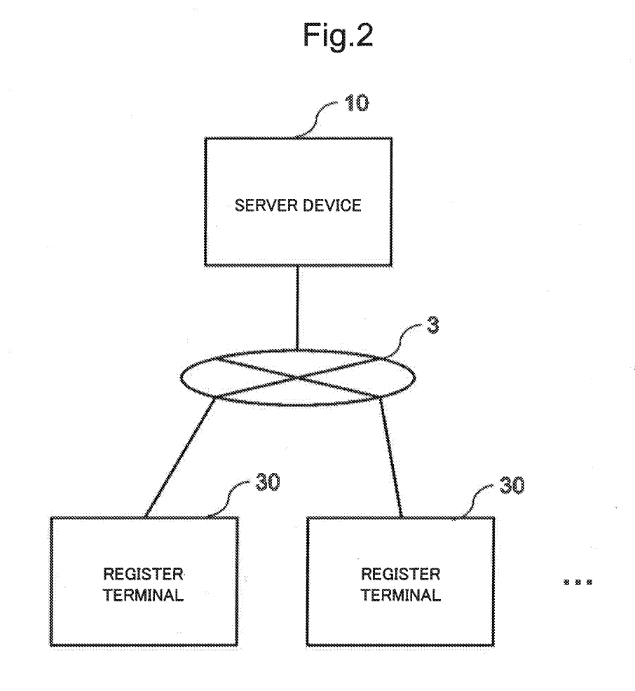

FIG. 2 is a diagram illustrating one example of a conceptual configuration of a settlement processing system 1 according to an example embodiment of the present invention.

The settlement processing system 1 of the present example embodiment includes a server device 10 and at least one register terminal 30 connected to the server device 10 via a network 3.

The settlement processing device 100 of the present example embodiment is achieved by combining the register terminal 30 and the server device 10.

In the present invention, it is assumed that the server device 10 is a server that manages information of a store, but, without limitation thereto, may further include a head-office server that manages information of a plurality of stores. In another form, any of a configuration in which the register terminal 30 of each store is directly connected to a head-office server, a configuration in which the server device 10 of each store is connected to a head-office server, and a combination of these is applicable.

In another example embodiment, the settlement processing device 100 may be achieved only by the register terminal 30. Function sharing between the server device 10 and the register terminal 30 is not specifically limited. In the present example embodiment, for example, functions of the selecting unit 108 and the product displaying unit 110 of the settlement processing device 100 may be achieved by the server device 10.

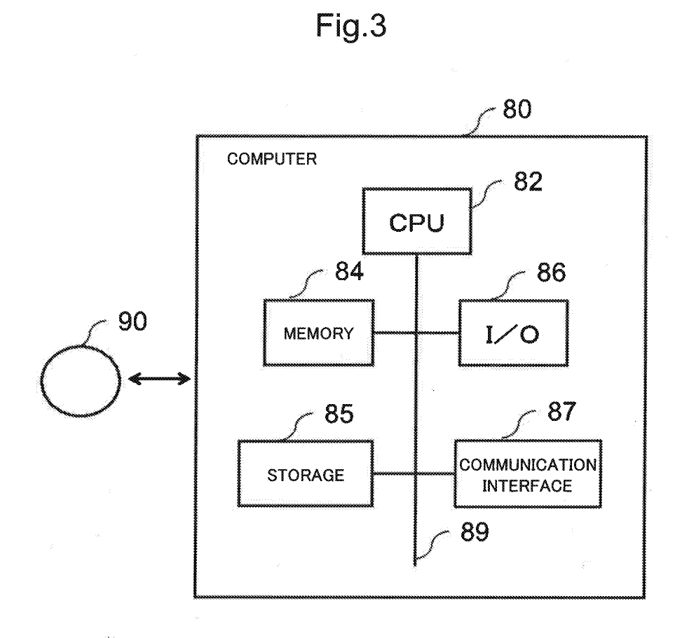

FIG. 3 is a diagram illustrating one example of a configuration of a computer 80 that achieves the server device 10 of the present example embodiment.

The computer 80 of the present example embodiment includes a central processing unit (CPU) 82, a memory 84, a program 90 that is loaded on the memory 84 and achieves the components of FIG. 2, a storage 85 that stores the program 90, an input/output (I/O) 86, and a network-connection interface (a communication interface 87).

The CPU 82, the memory 84, the storage 85, the I/O 86, and the communication interface 87 are mutually connected via a bus 89, and the entire server device 10 is controlled by the CPU 82. However, a method for mutually connecting the CPU 82 and the like is not limited to bus connection.

The memory 84 is a memory such as a random access memory (RAM), or a read only memory (ROM). The storage 85 is a storage device such as a hard disk, a solid state drive (SSD), or a memory card. Further, the storage 85 may be a memory such as a RAM or a ROM.

The CPU 82 reads the program 90 stored on the storage 85 onto the memory 84 and executes the read program 90, and thereby can achieve each function of the server device 10.

The I/O 86 executes input/output control of data and a control signal between the computer 80 and another input/output device. The another input/output device includes, for example, an input device such as a keyboard, a touch panel, a mouse, and a microphone connected to the computer 80, an output device such as a display, a printer, and a speaker, and an interface between these input/output devices and the computer 80. Further, the I/O 86 may execute input/output control of data of another recording medium for a reading or writing device.

The communication interface 87 is a network-connection interface for performing communication between the computer 80 and an external device. The communication interface 87 may be a network interface for connection to a wired line or a network interface for connection to a wireless line. The computer 80 that achieves the server device 10 is connected to, for example, a computer 50 that achieves the register terminal 30 by the communication interface 87 via the network 3.

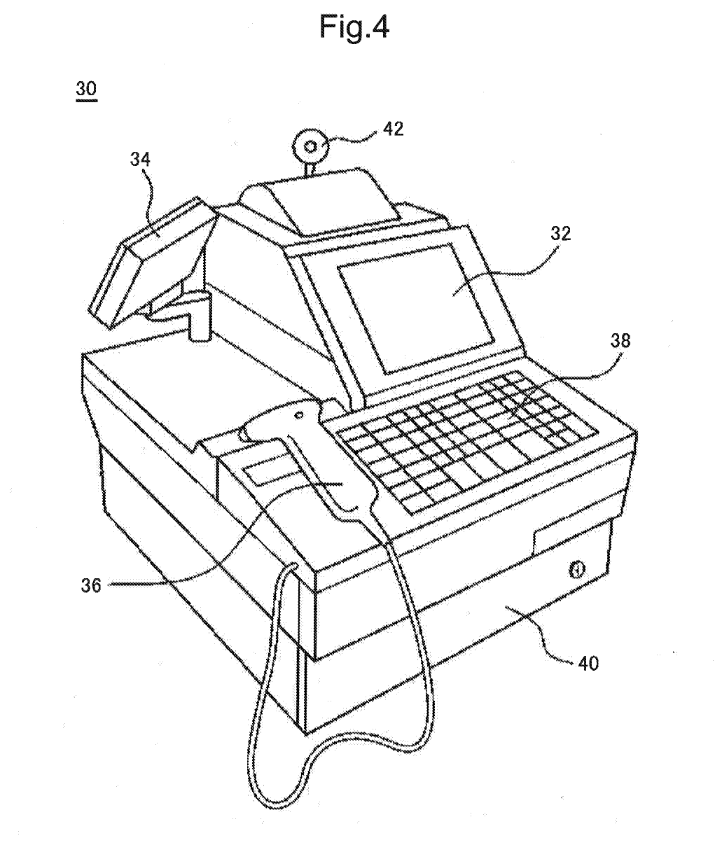

FIG. 4 is a perspective view illustrating an external appearance of the register terminal 30 that achieves the settlement processing device 100 of the present example embodiment.

The register terminal 30 of the present example embodiment includes a store clerk display 32, a customer display 34, a scanner 36, an input button 38, a drawer 40, and a camera 42.

The store clerk display 32 is a display including a function of a touch panel, displays various types of screens, and accepts input for operating the register terminal 30 by a store clerk. The customer display 34 is a display including a function of a touch panel, displays various types of screens, and accepts input for operating a screen by a customer.

The scanner 36 is a handy-type scanner and is various types of reading devices used to register a product of a settlement target. The scanner 36 is a bar code reader that reads a code attached to a product or a camera for performing image recognition of a product and a code attached to the product. The input button 38 is an input means which accepts a pressing operation of a store clerk. The drawer 40 stores coins and bills. The camera 42 image-captures a face of a customer in the vicinity of the register terminal 30, e.g., a customer performing settlement for a product with the register terminal 30.

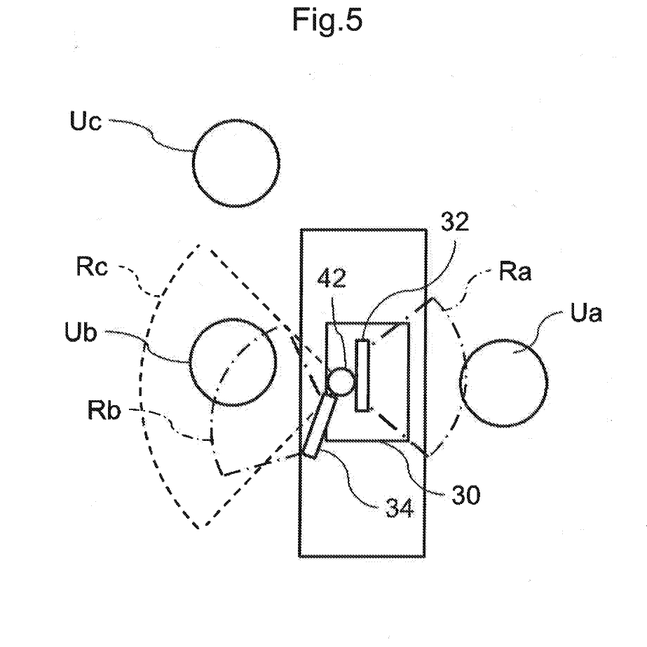

As illustrated in FIG. 5, the store clerk display 32 is disposed in a location and a direction where a store clerk Ua executing product registration processing and settlement processing by operating the register terminal 30 is located within a range Ra of a viewing angle of a screen of the display. The customer display 34 is disposed in a location and a direction where a customer Ub in the vicinity of the register terminal 30, e.g., a customer performing payment for a product at the register terminal 30, is located within a range Rb of a viewing angle of a screen of the display.

Further, it is assumed that an imaging range (image angle) Rc and a focal length of the camera 42 are manually or automatically controlled in such a way as to be able to image-capture at least the face of a customer Ub to be imaged. In other words, an image generated by the camera 42 includes at least the face of the customer Ub. The image may further include at least a part of clothes of the upper body of the customer Ub. An image to be captured may be a still image or a video. Preferably, the face of a customer Uc waiting for payment next to the customer Ub is not located within the imaging range Rc.

However, in another example, faces of a plurality of customers are set to be in an imaging range, and thereby image data of the plurality of customers may be generated. A form in which processing is executed based on image data of a plurality of customers will be described later.

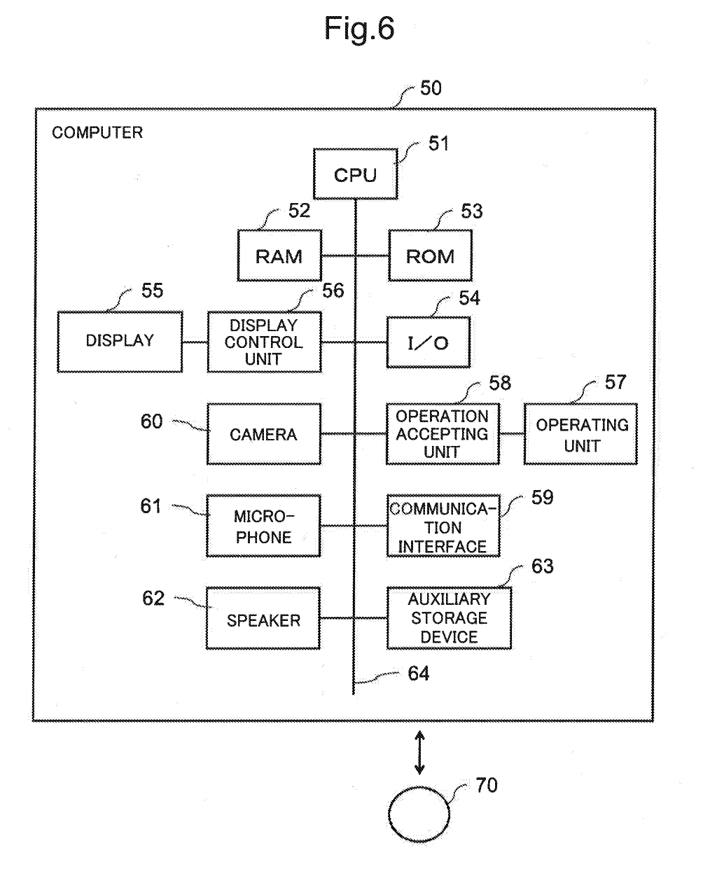

FIG. 6 is a diagram illustrating one example of a configuration of the computer 50 that achieves the register terminal 30 of FIG. 4.

The computer 50 of the present example embodiment includes a CPU 51, a RAM 52, a ROM 53, an I/O 54, a display 55, a display control unit 56, an operating unit 57, an operation accepting unit 58, a communication interface 59, a camera 60, a microphone 61, a speaker 62, and an auxiliary storage device 63. Respective elements of the computer 50 are connected via a bus 64, and the register terminal 30 is totally controlled by the CPU 51. However, a method for mutually connecting the CPU 51 and the like is not limited to bus connection.

The CPU 51 reads the program 70 stored on the ROM 53 or the auxiliary storage device 63 onto the RAM 52 and executes the read program 70, and thereby each function of the register terminal 30 can be achieved.

The auxiliary storage device 63 is a storage such as a hard disk, a solid state drive (SSD), or a memory card.

The I/O 54 executes input/output control of data and a control signal between the computer 50 and another input/output device. The other input/output device includes, for example, an input device such as a touch panel connected to the computer 50 or a touch panel of the store clerk display 32 of the register terminal 30, a touch panel of the customer display 34, the scanner 36, the input button 38, a microphone, and the like, an output device such as the store clerk display 32, the customer display 34, a printer, a speaker, and the like, and an interface between these input/output devices and the computer 50. Further, the I/O 54 may execute input/output control of data of another recording medium for a reading or writing device.

The printer is used, for example, to print out an accounting content of a customer onto a receipt.

The communication interface 59 is a network-connection interface for performing communication between the computer 50 and an external device.

The communication interface 59 may be a network interface for connection to a wired line or a network interface for connection to a wireless line. The computer 50 that achieves the register terminal 30 is connected to, for example, the computer 80 that achieves the server device 10 by the communication interface 59 via the network 3 or a computer 50 that achieves another register terminal 30.

The display 55 corresponds to the store clerk display 32 and the customer display 34 of FIG. 4. The display control unit 56 displays various types of screens on the display 55 in accordance with control from the CPU 51. The product display unit 110 of FIG. 1 displays a recommended product to a customer by using the display control unit 56 and the display 55.

The operating unit 57 corresponds to the touch panel of the store clerk display 32, the touch panel of the customer display 34, and the input button 38 of FIG. 4. The operation accepting unit 58 notifies the CPU 51 of input accepted by the operating unit 57.

The camera 60 corresponds to the camera 42 for imaging a customer of FIG. 4. The image data generating unit 106 of FIG. 1 image-captures the face of a customer by using the camera 60 and generates image data.

The microphone 61 performs voice input, and the speaker 62 performs voice output. For example, a message can be output by a voice to a customer via the speaker 62, and an appeal can be made by music. Further, a voice of a customer may be collected via the microphone 61, and the microphone 61 may be used as an input means instead of a touch panel operation and the like.

Each component of FIG. 1 of the settlement processing device 100 of the present example embodiment is achieved by any combination of hardware and software of the computer 80 and the computer 50. Those skilled in the art can understand that there are various modified examples in the achievement method and device. Each figure to be described below illustrates not a configuration of a hardware unit but a block of a function unit.

Further, in each figure described below, a configuration of a portion that does not relate to the essence of the present invention is omitted and is not illustrated.

A computer program according to an example embodiment of the present invention may be a program that causes at least one computer to execute a data processing method according to an example embodiment of the present invention to be described later or may be a computer-readable recording medium recording such a program. The recording medium includes a non-transitory, tangible medium.

The computer program includes, when being executed by a computer, a computer program code that causes the computer to execute the data processing method on the settlement processing device 100.

The computer program according to the example embodiment of the present invention is described in a such a way as to cause a computer (one or a combination of 50 and 80) to execute a step of registering a product by reading product identification information from the product, a step of executing settlement processing for the product registered in the step of registering a product, a step of generating image data by image-capturing a customer in front of an settlement processing device (the register terminal 30), a step of selecting a product to be recommended to the customer by using the image data, and a step of displaying the product selected in the step of selection to the customer in a selectable manner after the settlement processing in the step of executing settlement processing or the product registration processing in the step of registering a product is started.

The computer program of the present example embodiment may be recorded on a computer-readable recording medium. The recording medium is not specifically limited, and various forms are conceivable. Further, the program may be loaded on a memory of a computer from a recording medium or may be downloaded on a computer via a network and loaded on a memory.

A recording medium recording the computer program includes a non-transitory, tangible computer-usable medium, and a computer-readable program code is embedded in the medium. When being executed on a computer, the computer program causes the computer to execute a data processing method that achieves the settlement processing device 100. The data processing method for the settlement processing device 100 of the present example embodiment will be described later.

Returning to FIG. 1, in the settlement processing device 100 of the present example embodiment, the product registering unit 102 reads product information by using the scanner 36 of the register terminal 30 of FIG. 4 and registers a product. Specifically, a code read by the scanner 36 is converted to a product code, a purchase number is input by operating, by a store clerk, the touch panel of the store clerk display 32 or the input button 38 as necessary, and the purchase number is registered in settlement information of a customer, together with a product ID.

The product ID refers to identification information uniquely assigned to a product able to be sold or ordered in a store. Registration processing for a product executed by the product registering unit 102 is hereinafter referred to as product registration processing. By the product registration processing, settlement information is generated. Further, for a specific method for generating settlement information regarding a product a bar code of which is read by the scanner 36 or the like, various known techniques are usable, and therefore description on the method will be omitted.

When all registrations of products purchased by a customer are terminated, a store clerk inputs an accounting instruction by operating the touch panel of the store clerk display 32 or the input button 38.

Thereby, settlement information generated in the product registering unit 102 is transferred to the settlement processing unit 104. The settlement processing unit 104 accepts the settlement information generated in the product registering unit 102 and becomes in a state of waiting for payment from the customer. At that time, the drawer 40 may automatically open. When the customer pays the price to the store clerk, the store clerk receives the paid money, pays change as necessary, and closes the drawer 40. At the time, one piece of settlement processing is terminated for one customer.

These functions of the product registering unit 102 and the settlement processing unit 104 are similar to a function of a common register terminal 30 and are not specifically limited, and therefore various forms are conceivable.

In the case of a register terminal 30 including, for example, an automatic change machine, the register terminal 30 accepts input of money and pays change. For reading product information, for example, using a noncontact IC and the like, reading is executed by an IC reader.

The image data generating unit 106 image-captures, by the camera 42 of FIG. 4 (the camera 60 of FIG. 6), a customer in front of the register terminal 30, i.e. a customer being currently purchasing a product and generates image data. The image data generated by the image data generating unit 106 are transferred to the selecting unit 108. As described above, the image data generated by the image data generating unit 106 may be a still image or a video, and a file format is not specifically limited.

The selecting unit 108 first extracts an attribute of the customer by using the image data received from the image data generating unit 106. Feature information of the image data is acquired, and, for example, a gender, an age group, and a fashion of the customer are identified based on the feature information.

The fashion is identified, not limited to the following, for example, by a genre (casual, student, business, formal, sporty, natural, feminine, punk-rock style, kimono, or the like), a brand, a color, or a pattern (an animal, a leopard pattern, polka dots, stripes),

As these methods for image recognition, a known or own method may be used, and since image recognition itself is not a feature of the present invention, detailed description will be omitted. A corresponding product is selected based on an attribute of an identified customer as a product to be recommended to the customer. In the present invention, a product to be recommended to a customer includes a product having been previously purchased by the customer, and not only a new product can be recommended to the customer but also repeat purchase of a product can be recommended to the customer.

Various correspondence relations between an attribute of a customer and a product are conceivable, and according to an attribute of a customer and a product, a plurality of correspondence relations may be combined.

When, for example, attention is paid to a gender as an attribute of a customer, a product for men, a product for women, and a product having no relation with a gender are associated respectively. Further, when as an attribute of a customer, attention is paid by combining an age group and a gender, a product for female students in their teens, a product for female office workers of their twenties, a product for homemakers in their twenties to thirties, a product for a senior generation in their fifties or more, and the like are associated, respectively, combining an age group and a gender. Further, an attribute of a customer may be associated with a product.

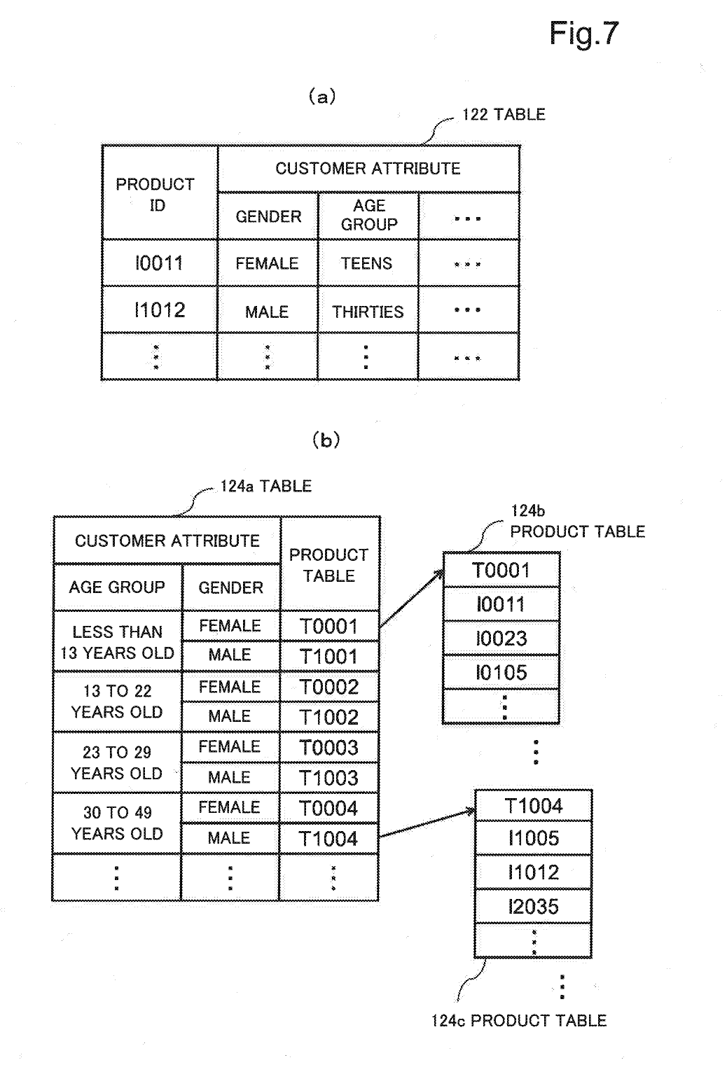

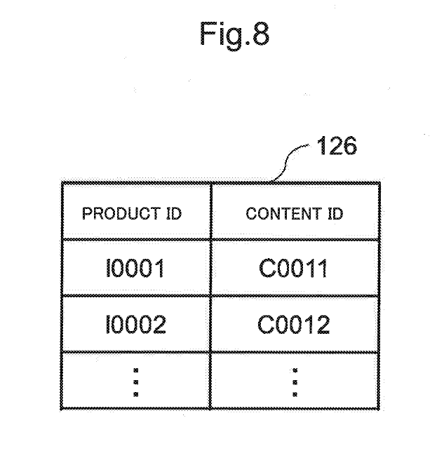

FIGS. 7 and 8 each are a diagram illustrating one example of a structure of the database 120 connected to the settlement processing device 100 of the present example embodiment.

The database 120 of the present example embodiment includes correspondence tables 122 and 124 of a customer attribute and a product illustrated in FIG. 7, a correspondence table 126 of a product and a content illustrated in FIG. 8, and a content storage unit that is not illustrated.

FIG. 7(a) illustrates an example of the correspondence table 122 in which a corresponding attribute of a customer is associated for each product. FIG. 7(b) illustrates an example of a table 124a in which corresponding product tables 124b, 124c, and the like are associated with attributes of customers, respectively. A plurality of tables may be combined in this manner, and various structures of the database 120 are conceivable without limitation to those described above.

In FIG. 8, a content displayed on a screen for recommending each product to a customer is associated with each product. In this example, a content ID is associated with each product, but a content ID may be associated with each product series and various forms are conceivable. A product table of FIG. 7(b) may be associated with a content ID. In the content storage unit, content data (e.g. a hypertext markup language (HTML) file, an image file, a moving image file, a voice file and the like) for displaying a screen are stored in association with a content ID.

The product display unit 110 is not specifically limited as long as it is a configuration capable of acquiring a content for displaying a screen of a content for recommending a product selected by the selecting unit 108 from the content storage unit of the database 120 and displaying the screen.

In the present example embodiment, a configuration for extracting, using image data, an attribute of a customer and using the acquired attribute for selection is made, however, without limitation thereto. As described in an example embodiment to be described later, a product relating to a customer may be selected based on customer information including at least one of an image acquired by image capture, a feature value extracted from the image, or information of an age group, a gender, and a fashion of the customer identified from the image.

Returning to FIG. 1, the product displaying unit 110 displays a product selected by the selecting unit 108 to a customer in a selectable manner after settlement processing by the settlement processing unit 104 or product registration processing by the product registering unit 102 is started.

A method for acquiring a content may be any one of the following methods.

(a1) A product ID selected by the selecting unit 108 is notified to the product displaying unit 110, and the product displaying unit 110 refers to the correspondence table 126 of FIG. 8 and the content storage unit, acquires content data corresponding to the product ID, and generates and displays a screen.

(a2) The correspondence table 126 of FIG. 8 is referred to, based on a product ID selected by the selecting unit 108, a content ID is acquired and notified to the product displaying unit 110, and the product displaying unit 110 refers to the content storage unit, acquires content data from the content ID, and generates and displays a screen.

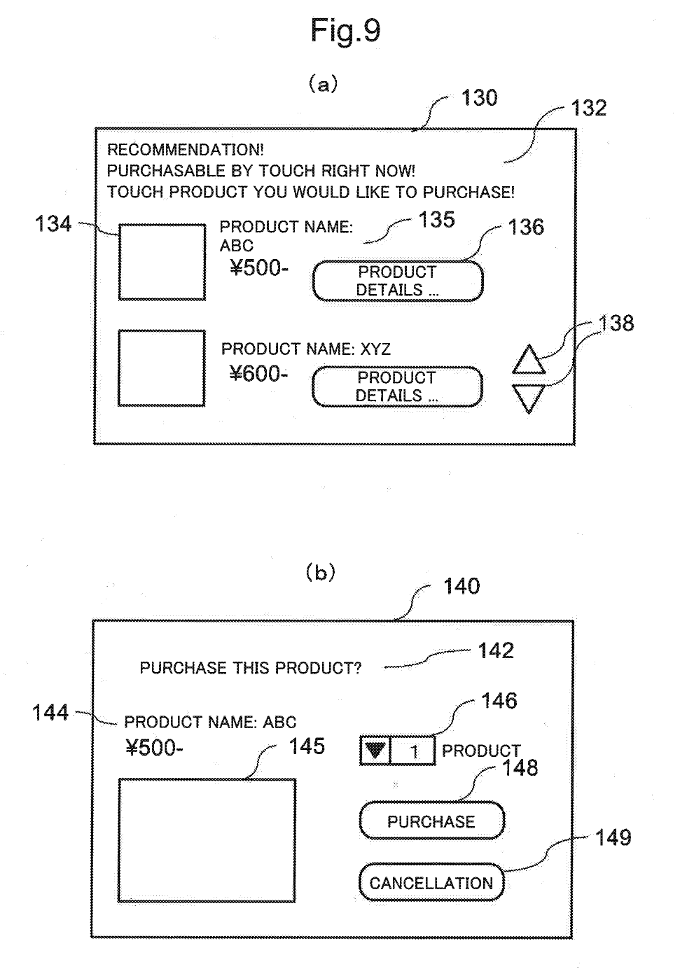

The product displaying unit 110 displays a screen 130 as illustrated in FIG. 9(a) on the customer display 34 of FIG. 3.

FIG. 9 is a diagram illustrating an example of a screen displayed by the product displaying unit 110 of the settlement processing device 100 of the present example embodiment.

The screen 130 of FIG. 9(a) includes a message displaying unit 132, a product image displaying unit 134, a product information displaying unit 135, a product detail information operating unit 136, and a page operating unit 138.

The message displaying unit 132 is an area for notifying a customer of existence of a recommended product and displaying a message for indicating an order operation method (touch). The product image displaying unit 134 is an area for displaying an image of a recommended product. In the present example embodiment, the product image displaying unit 134 doubles as an order operating unit for a product, and when a customer touches the product image displaying unit 134, a screen 140 of FIG. 9(a) is displayed.

The product information displaying unit 135 is an area for displaying information of a recommended product, e.g., information such as a product name, a model, a price (an amount of money), a color, a size, a material, and the like. The product detail information operating unit 136 is an operating button for accepting an instruction of a customer for displaying detailed information of a recommended product. When the operation accepting unit 58 accepts an operation of the product detail information operating unit 136, a transfer to a display screen for detailed information of a product is made.

The page operating unit 138 is an icon for accepting an instruction of a customer for page feeding or page returning of the screen 130. When there is a plurality of recommended products, by an operation of the page operation unit 138, a product is sequentially displayed by being switched.

A page feeding operation may be a configuration in which without an operation of a customer, a screen is automatically switched by a slide display method. Further, for an operation method, instead of an icon operation, another graphic user interface (GUI) (a scroll bar or the like) may be used, or a page operation may be performed by a flick or swipe operation. Further, other than a product image, a product video (an explanation video for a use method, a commercial video, or the like) and a voice (background music, a sound effect, an announcement, or the like) may be included.

As described above, the screen 130 includes a product image, a product name, a feature, and specifications of a recommended product, and may further include information of a discount rate of a product, information of point providing, information of coupon issuing, and a message for an advertisement.

The screen 140 of FIG. 9(b) includes a message displaying unit 142, a product information displaying unit 144, a product image displaying unit 145, a purchase number selecting unit 146, a purchase operating unit 148, and a cancellation operating unit 149.

The message displaying unit 142 is an area for displaying a message for confirming a will to purchase a product with a customer. The product information displaying unit 144 is an area for displaying information of a purchased product, e.g., information such as a product name, a model, a price (an amount of money), a color, a size, a material, and the like. The product image displaying unit 145 displays an image of a purchased product. A customer can confirm a product by product information and an image.

The purchase number selecting unit 146 is a list for accepting designation of a purchase number. Alternatively, another GUI such as a text box for inputting a purchase number is applicable. The purchase operating unit 148 is an operating button for accepting an instruction of a customer for determining purchase. The cancellation operation unit 149 is an operating button for accepting an instruction of a customer for cancelling purchase. Further, the screen 140 may include an operating unit that accepts designation of a color and a size of a product.

A data processing method of the settlement processing device 100 of the present example embodiment configured in this manner will be described below.

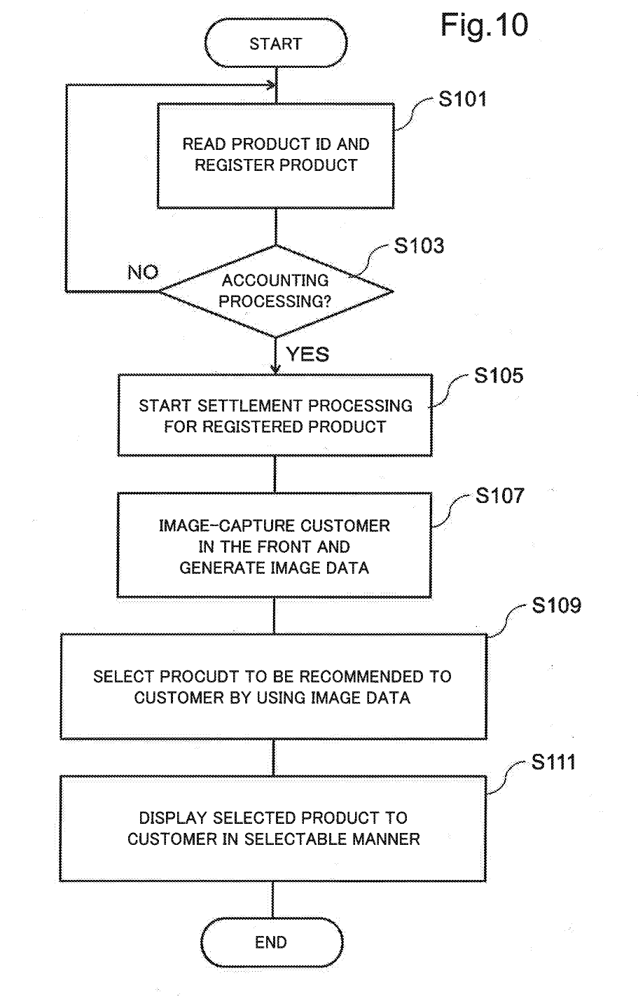

FIG. 10 is a flowchart illustrating one example of an operation of the settlement processing device 100 of the present example embodiment.

The data processing method according to the example embodiment of the present invention is a data processing method of the settlement processing device 100 and a data processing method executed by the computer 50 or the computer 80 that achieves the settlement processing device 100.

The data processing method of the present example embodiment includes, by using the settlement processing device 100, registering a product by reading product identification information from the product (step S101), executing settlement processing for the registered product (step S105), generating image data by image-capturing a customer in front of the settlement processing device 100 (step S107), selecting a product to be recommended to the customer by using the image data (step S109), and, after start of the settlement processing or the product registration processing (YES of step S103), displaying the selected product to the customer in a selectable manner (step S111).

Hereinafter, detailed description will be made.

A customer goes to the front of the register terminal 30 and passes a purchased product to a store clerk, and then the store clerk reads a bar code of the product by using the scanner 36 of the register terminal 30. The product registering unit 102 acquires a product ID converted from the bar code read by the scanner 36 and registers the acquired product ID in settlement information (step S101).

A settlement target in one piece of settlement processing may include a plurality of products. The product registering unit 102 registers, for example, one or a plurality of products registered between acceptance of an operation for an instruction for start of product registration processing for a settlement target and acceptance of an operation for an instruction for termination of the product registration processing for the settlement target as a settlement target in one piece of settlement processing.

The operation for an instruction for the termination of product registration of a settlement target is an operation for pressing a button that is, for example, “accounting”. The start of product registration processing for a settlement target is an operation (e.g., an operation for reading a product by the scanner 36) for reading a new product while, for example, previous product registration processing is completed.

Settlement information regarding certain settlement processing includes a product ID of each product registered as a target of the settlement processing. Further, the settlement information may further include a transaction number, an amount of money of each product, the number of purchase of products, and a settlement amount of money.

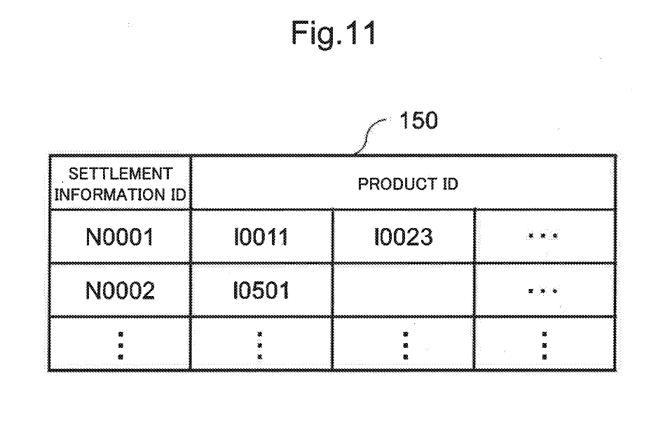

FIG. 11 is a diagram illustrating one example of settlement information generated by the product registering unit 102 of the settlement processing device 100 of the present example embodiment.

In settlement information 150, a settlement information ID assigned to each settlement and a product ID of each product registered as a target for the settlement processing are registered be being associated with each other.

In the example of FIG. 11, a settlement information ID (N0001) of settlement information generated by certain settlement processing is associated with two product IDs (I0011 and I0023). A settlement information ID (N0002) of settlement information generated by next settlement processing is associated with one product ID (I0501).

In the settlement information 150, member information of a customer, accounting date and time information, accounting terminal information, and member capacity information, and the like may be associated.

When a store clerk executes an operation for the “accounting” button of the touch panel of the store clerk display 32 of the register terminal 30 of FIG. 4, the operation accepting unit 58 of FIG. 6 accepts input by the operation and accepts the input as termination of product registration processing, i.e. a start operation for settlement processing (YES of step S103). While an operation for the “accounting” button is not executed (NO of step S103), product registration processing of step S101 is repeated.

The settlement processing unit 104 executes settlement processing. The settlement processing unit 104 receives settlement information from the product registering unit 102 and displays a total amount of money after accounting on the store clerk display 32 and the customer display 34. At that time, the drawer 40 opens. The store clerk receives the price from the customer and returns change to the customer as necessary. The store clerk stores money in the drawer 40 and closes the drawer 40. At that time, by accepting an operation for an operating button indicating “payment termination” displayed on the touch panel of the store clerk display 32, settlement processing may be terminated, or a time of detecting that the drawer 40 has been closed may be regarded as termination of settlement processing.

Processing for generating information of a recommended product and displaying the generated information to a customer is executed in steps S107, S109, and S111.

In the present example embodiment, while the above-described product registration processing and settlement processing are executed, i.e. while a customer stays in front of the register terminal 30, these pieces of processing are executed and information of a recommended product is displayed to the customer.

A method for processing steps regarding the recommended product information display of the present example embodiment is exemplified below.

(b1) After product registration processing or settlement processing is started, a customer in front of the register terminal 30 is image-captured by the camera 42, and generation of image data is started (step S107). A recommended product for the customer is selected using the image data (step S109), and a screen 130 is displayed on the customer display 34 (step S111).

(b2) Before product registration processing or settlement processing is started, a customer in front of the register terminal 30 is image-captured by the camera 42, and image data is generated (step S107). The generated image data are temporarily stored on a storage unit (e.g., the RAM 52 or the auxiliary storage device 63). After product registration processing or settlement processing is started, the image data are read from the storage unit, a recommended product for the customer is selected using the image data (step S109), and a screen 130 is displayed on the customer display 34 (step S111).

(b3) Before product registration processing or settlement processing is started, a customer in front of the register terminal 30 is image-captured by the camera 42, and image data is generated (step S107). A recommended product for the customer is selected using the image data (step S109). Information of the selected recommended product is temporarily stored on a storage unit (e.g., the RAM 52 or the auxiliary storage device 63). After product registration processing or settlement processing is started, the information of the recommended product is read from the storage unit, and a screen 130 of the information of the recommended product is displayed on the customer display 34 (step S111).

(b4) Before product registration processing or settlement processing is started, a customer in front of the register terminal 30 is image-captured by the camera 42, and image data is generated (step S107). A recommended product for the customer is selected using the image data (step S109), and a screen 130 is displayed on the customer display 34 (step S111).

Employment of any one of the timings can be appropriately determined, depending on, for example, accuracy of image data, image recognition accuracy, a customer number, a recommendation target product number, performance of a computer, a configuration of a system such as a memory capacity and the like, needed processing accuracy, a processing speed, the like.

In the settlement processing device 100 according to the example embodiment of the present invention, after product registration processing or settlement processing is started, using image data acquired by image-capturing a customer, a product to be recommended to the customer is selected by the selecting unit 108, and the selected product is displayed on the customer display 34 by the product display unit 110.

According to the settlement processing device 100 of the present example embodiment, using image data, information of an attribute such as an age group, a gender, and a fashion of a customer is extracted, and thereby an appropriate product can be recommended according to the attribute of the customer. A recommended product is selected according to an attribute of a customer, and therefore it is highly possible to recommend a product suitable for a preference of the customer and a purchase intention of the customer can be effectively increased, resulting in sales promotion. In other words, it is possible to select an advertisement having a high advertising effect and display the selected advertisement on the customer display 34.

### Second Example Embodiment

A settlement processing system 1 of a second example embodiment of the present invention will be described.

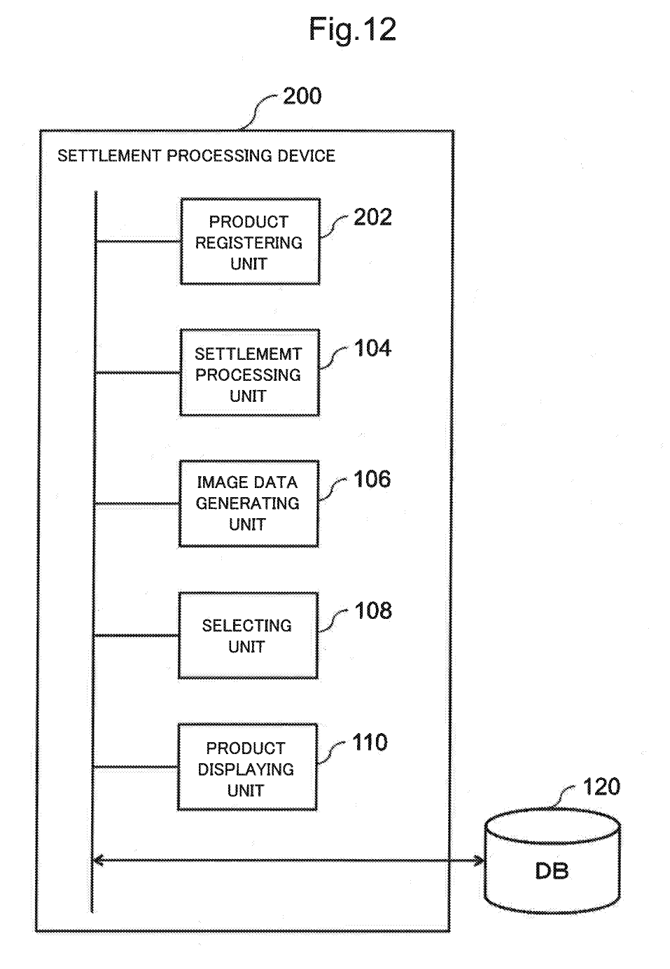

FIG. 12 is a function block diagram illustrating a logical configuration of a settlement processing device 200 of the present example embodiment.

The settlement processing device 200 of the present example embodiment is different from the above-described example embodiment in a point that a configuration in which an order of a customer for a recommended product displayed by a product display unit 110 is accepted is included.

The settlement processing device 200 of the present example embodiment includes a settlement processing unit 104, an image data generating unit 106, a selecting unit 108, and a product displaying unit 110 similarly to the settlement processing device 100 of the example embodiment of FIG. 1, and further includes a product registering unit 202.

In the settlement processing device 200 of the present example embodiment, the product registering unit 202 registers, when a customer selects a product displayed on the product displaying unit 110, the product.

Specifically, as described in the above-described example embodiment, while a customer stands in front of a register terminal 30, a screen 130 is displayed on a customer display 34 by the product displaying unit 110. After an operation for a product image of a product image displaying unit 134 of the screen 130 displayed on the customer display 34 is accepted, a screen 140 is displayed on the customer display 34. A purchase number and the like is designated by the screen 140, and when the customer operates a purchase operating unit 148, selection of a purchased product is accepted. As information of the selected product, a product ID is transferred to the product registering unit 202.

Further, while it is assumed that product selection on the screen 130 is accepted based on a touch operation by a customer in the product image displaying unit 134, for example, a configuration of using another method such as dragging onto a shopping cart, accepting an operation of another GUI, voice inputting, or the like is not excluded.

When accepting selection of a product, the product registering unit 202 receives information of the selected product, for example, a product ID, adds the product ID to already-generated settlement information, and regenerates settlement information. Until product selection of a customer is terminated, product registration processing is repeated. Settlement processing may be collectively executed at the time of completion of additional product registration, or may be executed every time a product is added.

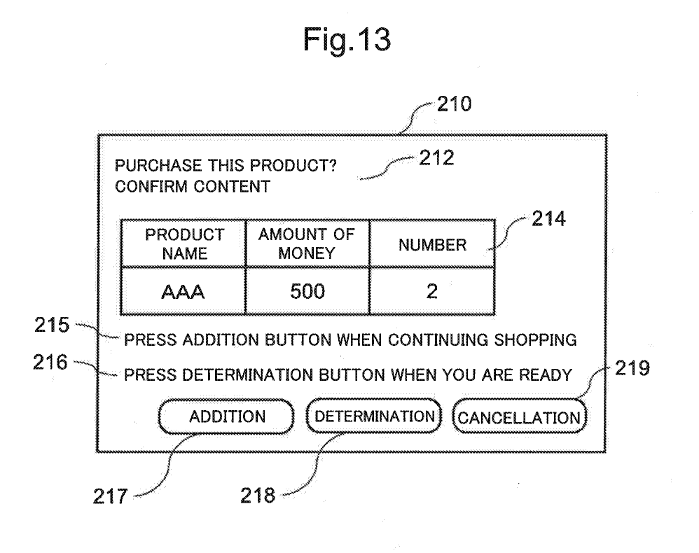

FIG. 13 is a diagram illustrating one example of a screen of an additional purchase product list displayed on the customer display 34 of the register terminal 30 of the present example embodiment.

A screen 210 includes a first message displaying unit 212, an additional purchase product list displaying unit 214, a second message displaying unit 215, a third message displaying unit 216, an addition operating unit 217, a determination operating unit 218, and a cancellation operating unit 219.

The first message displaying unit 212 is an area for displaying a message for confirming a will to purchase a product with a customer and encouraging the customer to confirm a content.

The additional purchase product list displaying unit 214 is an area for displaying a list of product information obtained by customer selection. In this example, only one product is displayed, but when a plurality of products is selected, information of all the products is displayed. Further, in this example, a display item includes a product name of a product, a unit price of the product, and a purchase number without limitation thereto. Information of color designation of a product and size designation may be also included. Information of a discount rate of a product, information of point providing, and information of coupon issuing may be included.

The second message displaying unit 215 is an area for displaying a message for inquiring of a customer about whether product selection (shopping) is continued and indicating an operation method (button pressing) upon being continued.

The third message displaying unit 216 is an area for displaying a message for inquiring of a customer about whether product selection (shopping) is terminated and shopping is determined and indicating an operation method (button pressing) upon being determined.

The addition operating unit 217 is an operating button for accepting an instruction of a customer for continuing shopping.

The determination operating unit 218 is an operating button for accepting an instruction of a customer for determining shopping.

The cancellation operating unit 219 is an operating button for accepting an instruction of a customer for cancelling shopping on the screen 210 displayed on the customer display 34.

In the preset example embodiment, it is assumed that the screen 210 is displayed on the customer display 34 and a customer executes all operations for selection of a product, determination of shopping, and cancellation, but in another form, it is possible that a customer tells a store clerk a product to be additionally purchased and the store clerk executes an operation. In this case, for example, the screen 210 is displayed also on a store clerk display 32 and the store clerk executes an operation instead of the customer. Further, a store clerk may select or modify a color, a size, a number and the like of a product to be additionally purchased.

An operation of the settlement processing device 200 of the present example embodiment configured in this manner will be described below.

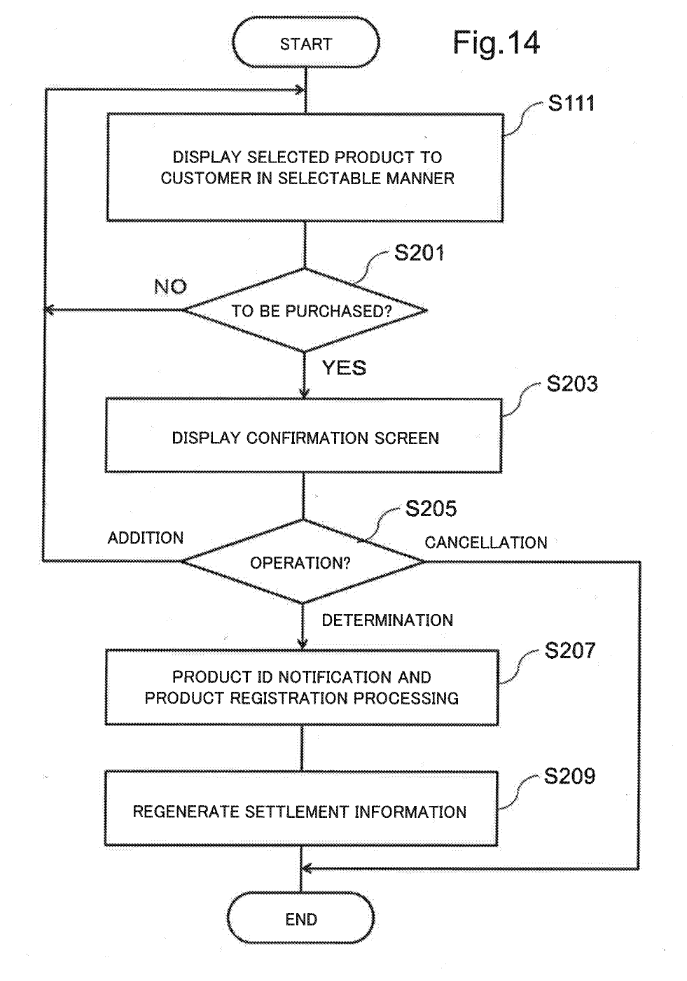

FIG. 14 is a flowchart illustrating one example of an operation of the settlement processing device 200 of the present example embodiment.

First, in the present example embodiment, while the screen 140 of FIG. 9(b) of the above-described example embodiment is displayed (step S111), processing is started.

When a customer operates the purchase operating unit 148 on the screen 140, the operation accepting unit 58 accepts the operation of the purchase operating unit 148 (YES of step S201), and the screen 210 of FIG. 13 is displayed on the customer display 34 by the product displaying unit 110 (step S203).

When the customer operates the addition operating unit 217 of the screen 210, the operation accepting unit 58 accepts the operation of the addition operating unit 217 (addition of step S205), and the product displaying unit 110 displays a screen 130 on the customer display 34 (step S111).

When the customer operates the determination operating unit 218 of the screen 210, the operation accepting unit 58 accepts the operation of the determination operating unit 218 (determination of step S205) and notifies the product registering unit 202 of information of an added product ID, and the product registering unit 202 executes product registration processing for the added product (step S207).

Settlement information is regenerated by the product registering unit 202 (step S209), and a total payment amount of money is displayed on the customer displaying unit 34, based on the regenerated settlement information. For a display method for a payment amount of money, display may be performed in a format in which not only a total amount of money but also a breakdown such as subtotals and respective subtotals for additional products, individual amounts of money of additional products, and the like are understood.

Further, when the customer operates the cancelation operating unit 219 of the screen 210, the operation accepting unit 58 accepts the operation of the cancellation operating unit 219 (cancellation of step S205), and the present processing is terminated by bypassing steps S207 and S209.

In the present figure, it is assumed that when purchase is determined on the screen 210, product registration processing is executed, but there is no limitation thereto. It is possible that when, for example, an operation of the purchase operating unit 148 is accepted on the screen 140, a product ID is notified to the product registering unit 202 and product registration processing of step S207 is executed. When an operation of the determination operating unit 218 is accepted on the screen 210, settlement information of step S209 may be regenerated. When an operation of the cancellation operating unit 219 is accepted after step S207, a product subjected to product registration is cancelled and settlement information is not regenerated.

In the settlement processing device 200 of the present example embodiment, a product selected to be additionally purchased by a customer is additionally registered by the product registering unit 202 among recommended products displayed on the customer display 34 by the product displaying unit 110, and settlement information is regenerated.

According to this configuration, an advantageous effect similar to the advantageous effect of the above-described example embodiment is produced and further a recommended product can be purchased or ordered by a customer on site. Therefore, convenience is improved for a customer, and for a store, sales can be efficiently promoted.

### Third Example Embodiment

A settlement processing system 1 of a third example embodiment of the present invention will be described.

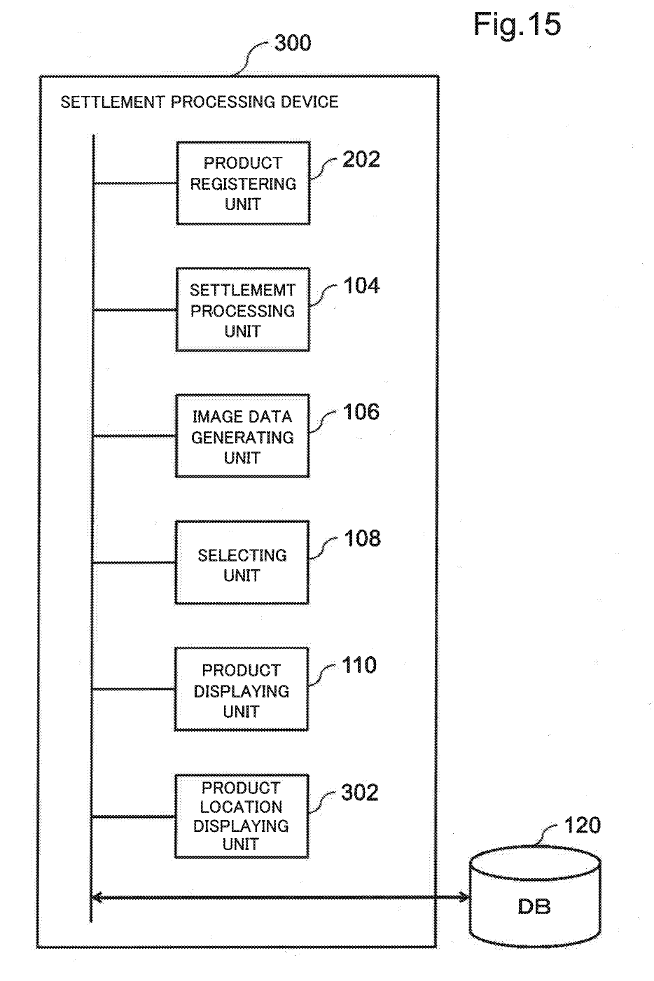

FIG. 15 is a function block diagram illustrating a logical configuration of a settlement processing device 300 of the present example embodiment.

The settlement processing device 300 of the present example embodiment is different from the above-described example embodiments in a point that a configuration in which a screen indicating a location of a product additionally selected by a customer is displayed is included.

The settlement processing device 300 of the present example embodiment includes a product registering unit 202, a settlement processing unit 104, an image data generating unit 106, a selecting unit 108, and a product displaying unit 110 similarly to the settlement processing device 200 of the example embodiment of FIG. 12, and further includes a product location displaying unit 302.

In the present example embodiment, an example of a combination with the settlement processing device 200 of FIG. 12 is described, but a combination with a settlement processing device of another example embodiment can be made appropriately when being uncontradictory.

In the present example embodiment, the settlement processing device 300 further includes the product location displaying unit 302 that displays a screen 310 indicating a location of the selected product.

In the present example embodiment, it is assumed that the product location displaying unit 302 displays the screen 310 on a store clerk display 32 and a store clerk goes and fetches a product, but in another example, it is possible that the screen 310 is displayed on a customer display 34 and a customer is asked to go and fetch, however, without specific limitation thereto. Further, the screen 310 may be displayed as information of the store clerk display 32 and the customer display 34.

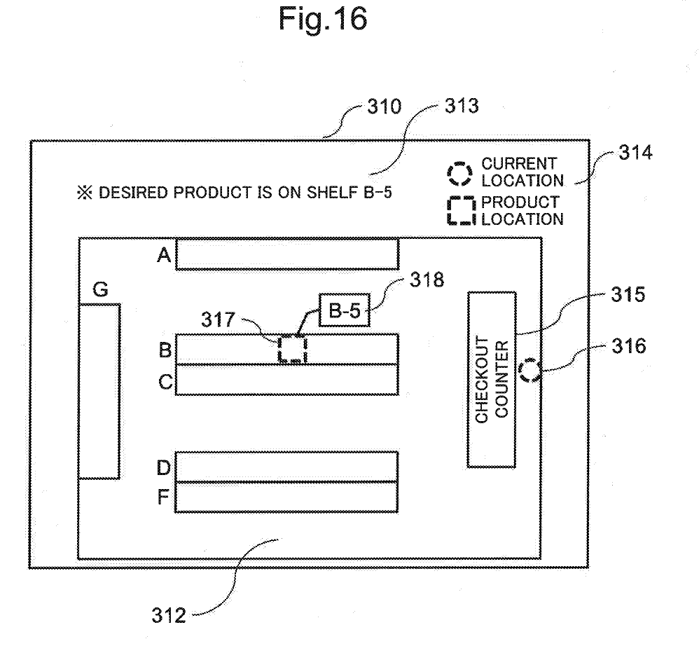

FIG. 16 is a diagram illustrating one example of the screen 310 displayed by the product location displaying unit 302 of the settlement processing device 300 of the present example embodiment.

The screen 310 includes a layout displaying unit 312, a message displaying unit 313, a symbol explanation displaying unit 314, a checkout counter location displaying unit 315, a current location displaying unit 316, a product location displaying unit 317, and a product location information displaying unit 318.

The layout displaying unit 312 is an area indicating a layout diagram of a store. It may be possible to move a display range and perform display in an enlarging or reducing manner by a touch panel operation. In the layout diagram, disposition of a checkout counter and shelves, a current location, and a product location are indicated. The layout diagram is one example, and without limitation thereto, various types of information such as floor information (such as the floor number and information of selling product types) of a store, passageway identification information, area identification information, shelf identification information, and the like may be included.

The message displaying unit 313 is an area for displaying a message for explaining a product location for a customer or a store clerk. An example in which a shelf number indicating a location of a shelf on which there is a product is displayed is illustrated. A message being displayed on the message displaying unit 313 in the example illustrated in FIG. 16 is an expression for a customer. When a message is displayed for a store clerk, the message may be a text other than this.

The symbol explanation displaying unit 314 is an area for displaying explanations of symbols indicating a current location and a product location, respectively.

The checkout counter location displaying unit 315 indicates a location of a checkout counter in a store.

The current location displaying unit 316 indicates a current location in the store. The product location displaying unit 317 indicates a product location in the store. The product location information displaying unit 318 indicates information indicating a product location in the store, here indicating a shelf number.

Further, a quantity of stock of a product may be further displayed together on the screen 310. Further, when there is no stock, delivery can be performed from a warehouse under separate cover based on a delivery procedure. Designation of a delivery destination will be described in an example embodiment to be described later. Further, when there is no stock, it is possible that stock information of other stores is displayed together and information of a nearest store having stocks is further displayed on the screen 310. Further, a configuration in which these contents of the screen 310 are printed out by a printer and the printed contents are passed to a customer may be further included.

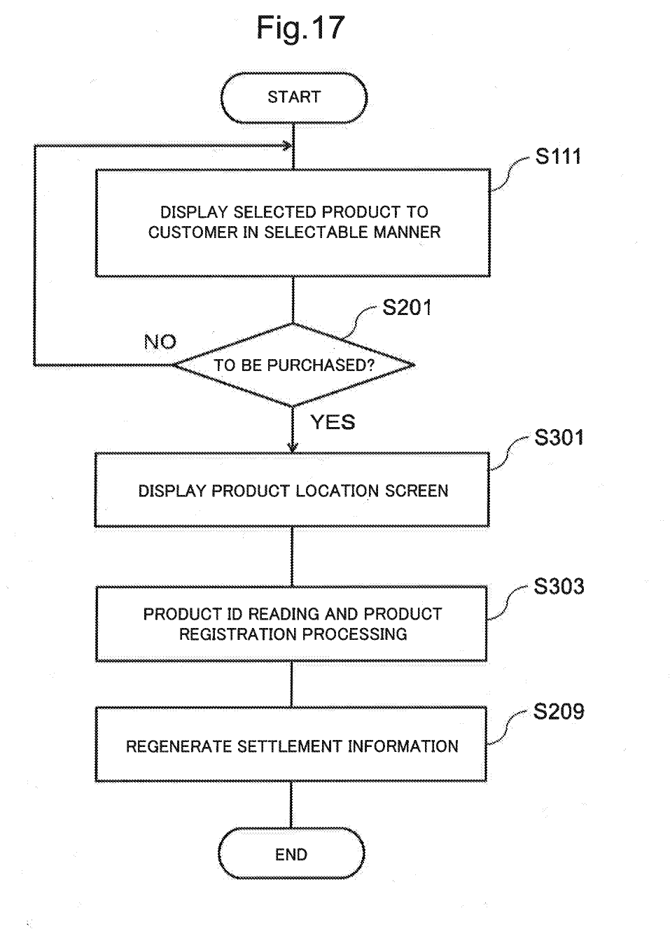

FIG. 17 is a flowchart illustrating one example of an operation of the settlement processing device 300 of the present example embodiment.

First, in the present example embodiment, while the screen 140 of FIG. 9(b) of the above-described example embodiments is displayed (step S111), processing is started.

When a customer operates the purchase operating unit 148 on the screen 140, the operation accepting unit 58 accepts the operation of the purchase operating unit 148 (YES of step S201), and the screen 310 of FIG. 16 is displayed on the store clerk display 32 by the product location displaying unit 302 (step S301). A store clerk confirms a product location and goes and fetches a product. A bar code is read from the product fetched by the store clerk, and the product registering unit 202 executes product registration processing (step S303).

Settlement information is regenerated by the product registering unit 202 (step S209), and a total payment amount of money is displayed on the customer displaying unit 34, based on the regenerated settlement information.

In the present example embodiment, while an example in which a store clerk goes and fetches a product, a bar code is read from the product, and product registration processing is executed has been described, step S203 and the following steps of the flowchart of FIG. 14 described in the settlement processing device 200 of the above-described embodiment may be executed in parallel. In other words, it is possible that the screen 210 of FIG. 13 is displayed on the customer display 34 by the product displaying unit 110, a customer executes determination processing for product purchase on the screen 210 in accordance with the step illustrated in FIG. 14 (determination of step S205), a product ID is transferred to the product registering unit 202, and the product registering unit 202 executes product registration processing (step S207).

In the settlement processing device 300 of the present example embodiment, information regarding a sales location of a product selected by a customer is displayed by the product location displaying unit 302.

According to this configuration, an advantageous effect similar to the advantageous effects of the above-described example embodiments is produced, and further a product location can be understandably conveyed to a customer or a store clerk, whereby trouble for searching a product during purchase can be saved. Even a store clerk who does not remember a product location can quickly respond and a satisfaction degree of a customer is increased.

### Fourth Example Embodiment

A settlement processing system 1 of a fourth example embodiment of the present invention will be described.

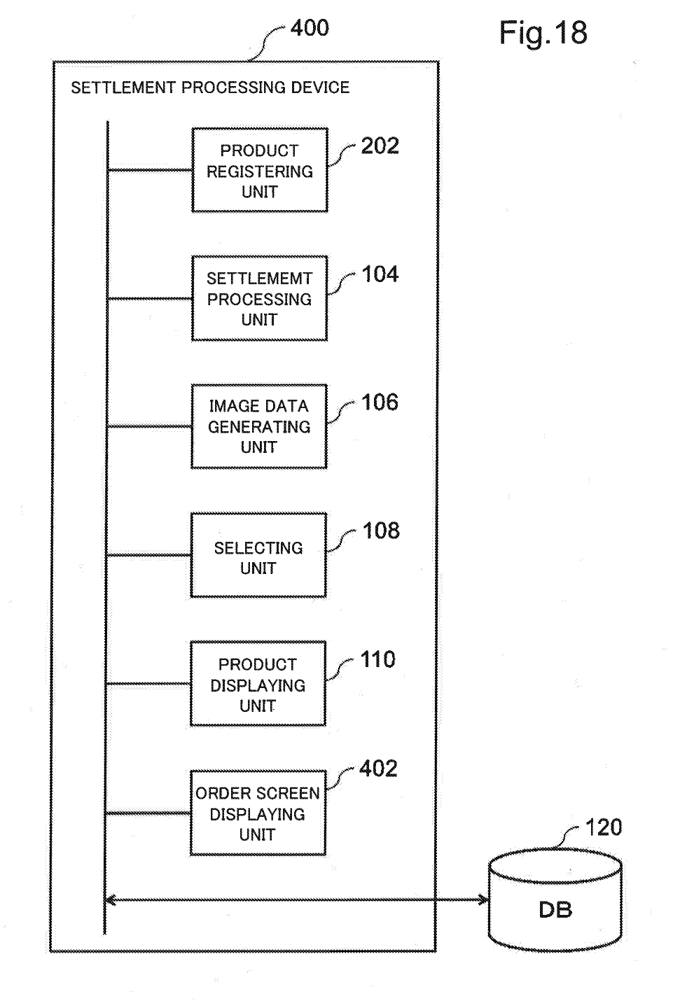

FIG. 18 is a function block diagram illustrating a logical configuration of a settlement processing device 400 according to the present example embodiment.

The settlement processing device 400 of the present example embodiment is different from the above-described example embodiments in a point that a configuration in which a screen for delivery processing for a product selected by a customer is displayed is included.

The settlement processing device 400 of the present example embodiment includes a product registering unit 202, a settlement processing unit 104, an image data generating unit 106, a selecting unit 108, and a product displaying unit 110 similarly to the settlement processing device 200 of the example embodiment of FIG. 12, and further includes an order screen displaying unit 402.

In the present example embodiment, an example of a combination with the settlement processing device 200 of FIG. 12 is described, but a combination with a settlement processing device of another example embodiment can be made appropriately when being uncontradictory.

In the present example embodiment, the settlement processing device 400 further includes the order screen displaying unit 402 that displays, when a product displayed on the product displaying unit 110 is selected by a customer, an input screen for delivery processing for the product.

Further, in the settlement processing unit 400, a database 120 may include a member information storage unit 404.

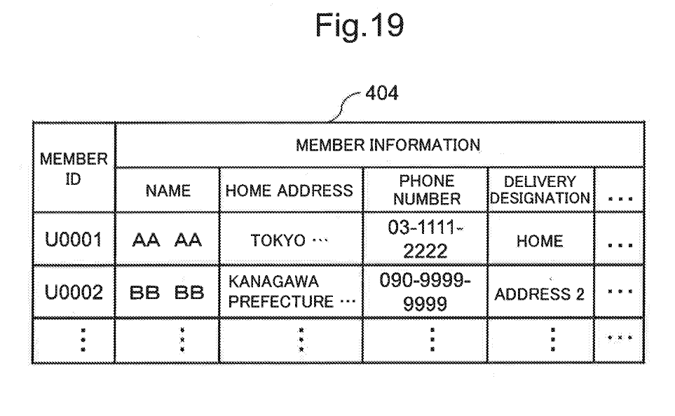

FIG. 19 is a diagram illustrating one example of a structure of the member information storage unit 404 of the settlement processing device 400 of the present example embodiment.

The member information storage unit 404 may be included in a server device 10, may be included in a register terminal 30, or may be an external storage device accessible by the server device 10 or the register terminal 30.

In the member information storage unit 404, member information such as a name of a member, Japanese syllabaries attached to Chinese characters (furigana), an address, a phone number, a mail address, and the like is stored in association with a member ID. A member registration method is not specifically limited, and various known methods may be executed. For a customer subjected to member registration, a membership card is distributed, and by presenting the membership card during shopping, member information and settlement information of shopping at that time may be associated with each other. Further, information about whether one's home is a normal delivery destination as delivery designation or an address other than one's home is designated as a normal delivery destination and information of an address of the delivery destination and the like may be further included. In the present example embodiment, a delivery destination can be determined based on the delivery designation information.

Further, in the settlement processing device 400, the database 120 may further include a delivery list 406.

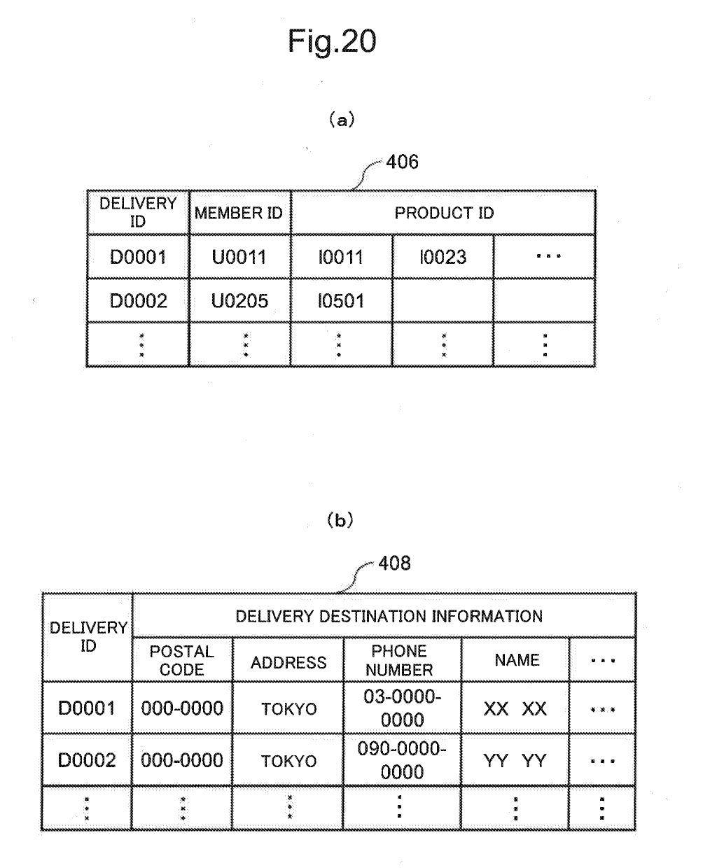

FIG. 20 is a diagram illustrating one example of a structure of a delivery list 406 and a delivery destination information list 408 included in the database 120 of the settlement processing device 400 of the present example embodiment.

The delivery list 406 records, in one delivery unit, a product ID of a product to be delivered selected and added by a customer among recommended products. Further, the database 120 may include the delivery destination information list 408 for each delivery.

The delivery destination information list 408 includes information (a postal code, an address, a phone number, a name, and the like) of a delivery destination for each delivery.

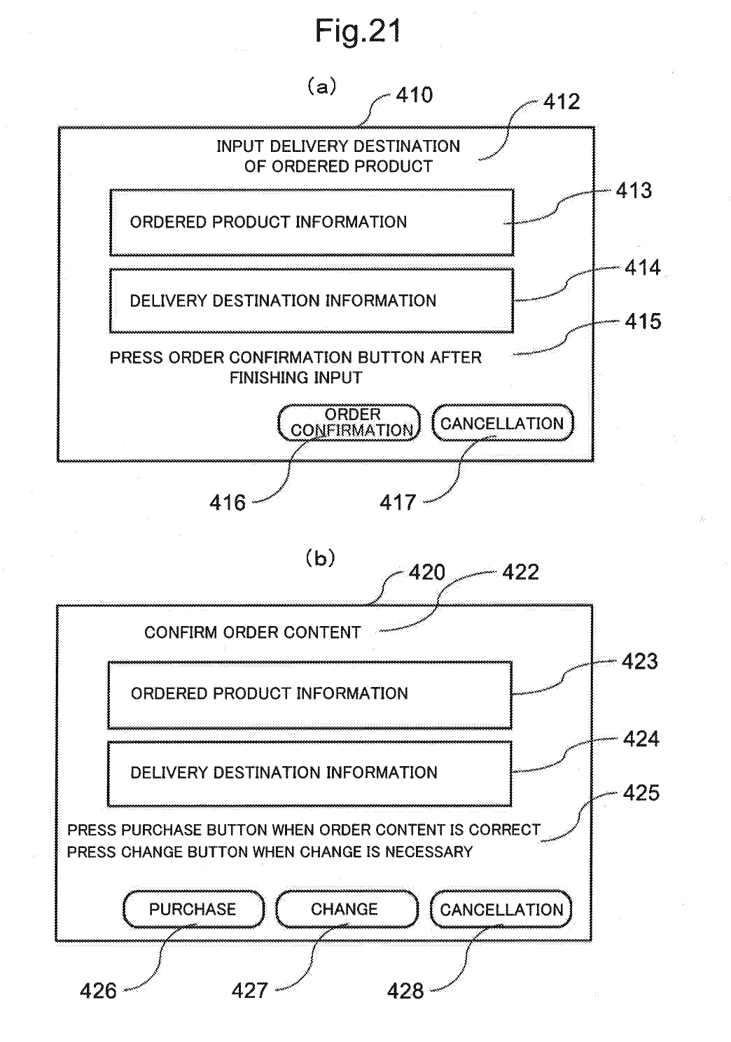

FIG. 21 is a diagram illustrating an example of an order screen displayed by the order screen displaying unit 402 of the settlement processing device 400 of the present example embodiment.

The order screen is a screen for designating a delivery destination of a product when, for example, a product in stock does not currently exist in a store or is a product that needs to be delivered among products ordered by a customer, on the screen 130 and the screen 140 displayed by the product displaying unit 110 and determined to be purchased by the screen 210.

The example of FIG. 21(a) is an example of a screen in which member information of a customer is not registered and a screen for asking a customer to input a delivery destination. The example of FIG. 21(b) is an example of a screen in which member information of a customer is already registered and a screen for acquiring a delivery destination from the member information storage unit 404, displaying the acquired delivery destination, and confirming the delivery destination with the customer.

Member information can be acquired from the member information storage unit 404. For example, a customer passes a membership card to a store clerk at the time of accounting, and the store clerk reads a bar code indicating identification information such as a member ID and the like by using the scanner 36 from the membership card of the customer or reads information from a magnetically recorded portion of the membership card by using a magnetic reading device that is not illustrated, and acquires the member ID. The member information storage unit 404 is accessed, and information of a home address of the member associated with the member ID or a registered address designated for delivery is acquired and transferred to the order screen displaying unit 402. Alternatively, it is possible that using a face image of a customer, authentication processing is executed by image recognition processing, a registered member is identified, and member information is acquired.

In the example of FIG. 21(a), when it is difficult to input a delivery destination by the touch panel of the customer display 34, it is possible that using another tablet terminal, member registration or address information is input and transmitted to the server device 10, and the information is transferred from the server device 10 to the register terminal 30 and displayed on the screen 410 or the screen 420 of the customer display 34. Member information is stored on the member information storage unit 404. In this case, after product registration processing, regeneration processing for settlement information and the like are finished, delivery destination information may be input using a tablet terminal or the like on the side of a checkout counter. Further, it is possible that member registration is recommended to a customer and member registration information is input by a tablet terminal.

The screen 410 of FIG. 21(a) includes a first message displaying unit 412, an ordered product information input unit 413, a delivery destination information input unit 414, a second message displaying unit 415, an order confirmation operating unit 416, and a cancellation operating unit 417.

The first message displaying unit 412 is an area for displaying a message for encouraging a customer to input a delivery destination of an ordered product. The ordered product information input unit 413 is an area for displaying product information obtained by an order of a customer.

The delivery destination information input unit 414 is an area to which information of a delivery destination of a product is input and displays a GUI (e.g., a list box or a text box and the like) for inputting a delivery destination. The second message displaying unit 415 is an area for displaying a message indicating an operation method (button pressing) for order confirmation after input of a delivery destination by a customer.

The order confirmation operating unit 416 is an operating button for accepting an instruction of a customer for order confirmation. The cancellation operating unit 417 is an operation button for accepting an instruction of a customer for cancelling the order.

When an operation accepting unit 58 accepts an operation of the order confirmation operating unit 416, the screen 420 of FIG. 21(b) is displayed on the customer display 34.

The screen 420 of FIG. 21(b) includes a first message displaying unit 422, an ordered product information displaying unit 423, a delivery destination information displaying unit 424, a second message displaying unit 425, a purchase operating unit 426, a change operating unit 427, and a cancellation operating unit 428.

The first message displaying unit 422 is an area for displaying a message for encouraging a customer to confirm an order content.

The ordered product information displaying unit 423 is an area for displaying product information obtained by an order of a customer. The delivery destination information displaying unit 424 is an area for displaying information of a delivery destination of a product.

The second message displaying unit 425 is an area for encouraging a customer to determine an order when an order content is correct and displaying a message for indicating an operation method (button pressing) for order determination and an operation method (button pressing) in the case of a change.

The purchase operation unit 426 is an operating button for determining an order for a product and accepting an instruction of a customer for purchasing the product. The change operating unit 427 is an operating button for accepting a change instruction of a customer for an order content or a delivery destination content. The cancellation operating unit 428 is an operating button for accepting an instruction of a customer for canceling an order.

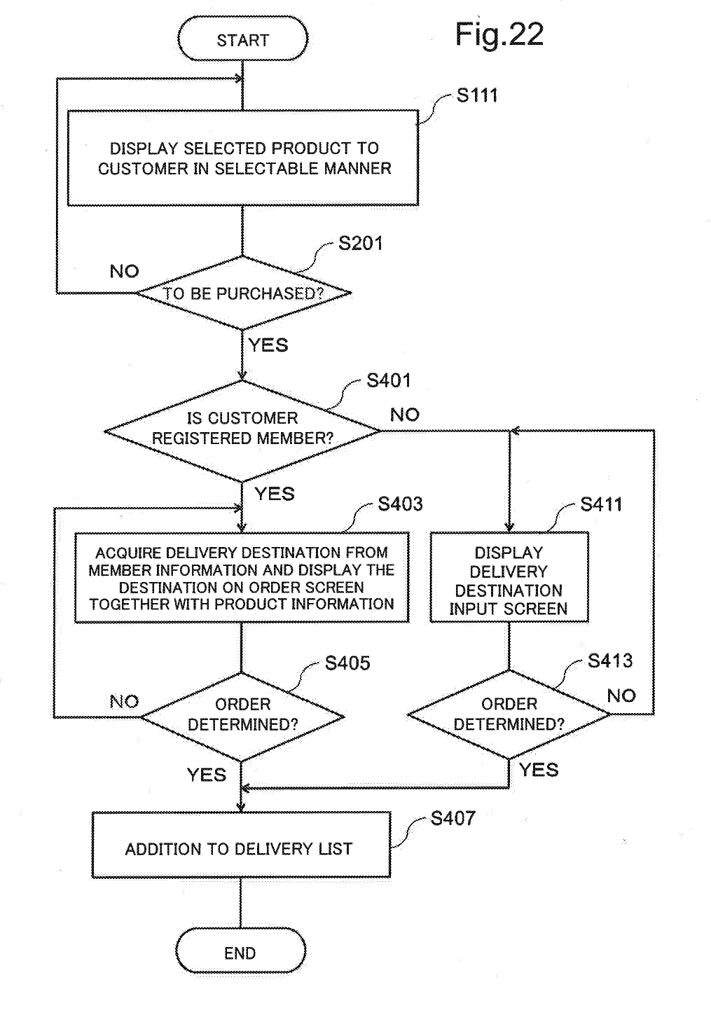

FIG. 22 is a flowchart illustrating one example of an operation of the settlement processing device 400 of the present example embodiment.

In the present example embodiment, although not illustrated, before or after step S101 of FIG. 10, a step of accepting a membership card from a customer and acquiring a member ID from the membership card is further included. The acquired member ID may be associated with the settlement information 150 of FIG. 11.

In the present example embodiment, while the screen 140 of FIG. 9(b) of the above-described example embodiments is displayed (step S111), processing is started.

When a customer operates a purchase operating unit 148 on the screen 140, the operation accepting unit 58 accepts the operation of the purchase operating unit 148 (YES of step S201) and determines whether there is a member ID read from a membership card.

When there is a member ID, a customer is determined as a registered member (YES of step S401), and the order screen displaying unit 402 accesses the member information storage unit 404, acquires member information corresponding to the member ID, acquires information of a delivery destination from the member information, and displays the acquired information on the screen 420 of FIG. 21(b), together with product information (step S403).

When the operation accepting unit 58 accepts an operation of the purchase operating unit 426 by the customer, the order screen displaying unit 402 determines that an order is determined (YES of step S405) and adds a product ID and delivery destination information to the delivery list 406 of FIG. 20(a) and the delivery destination information list 408 of FIG. 20(b) (step S407), and the present processing is terminated.

As described above, in the settlement processing device 400 of the present example embodiment, an input screen for delivery processing for a product is displayed by the order screen displaying unit 402.

According to this configuration, an advantageous effect similar to the advantageous effects of the above-described example embodiments is produced, and further delivery designation can be performed together with placement of an order when there is no product in stock or for a product desired to be delivered, and therefore it is possible that a recommended product is purchased in a store with a feeling such as Internet mail order and the purchased product is delivered, resulting in high convenience for a customer.

### Fifth Example Embodiment

A settlement processing system 1 of a fifth example embodiment of the present invention will be described.

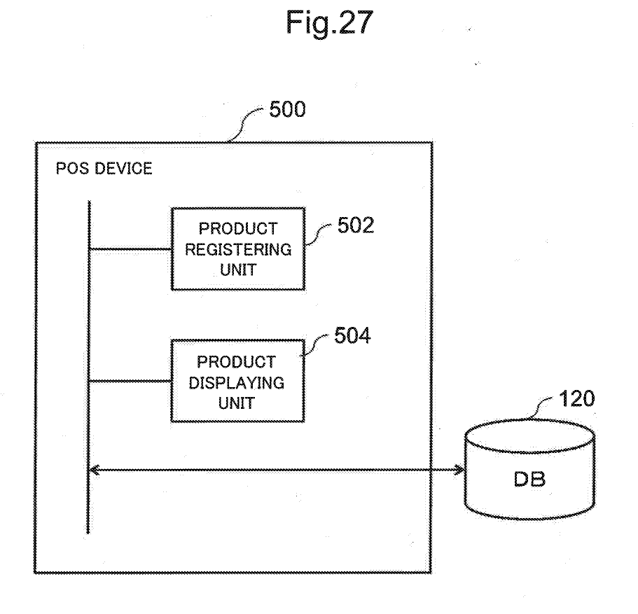

FIG. 27 is a function block diagram illustrating a logical configuration of a POS device 500 according to the example embodiment of the present invention.

The POS device 500 of the present example embodiment includes a minimum configuration of the present invention. While in the above-described example embodiments, a configuration in which a settlement processing device includes a product registering unit 102 and a settlement processing unit 104 has been described, the POS device 500 of the present example embodiment may be a configuration in which a settlement processing unit 104 is not included or may be a so-called semi-self-service POS device.

Further, the POS device 500 is accessibly connected to a database 120. The database 120 may be included in the POS device 500 or may be included in an external device different from the POS device 500 or a recording medium. The POS device 500 of the present example embodiment can be combined with at least any one of the other example embodiments.

The POS device 500 of the present example embodiment can be achieved, for example, by the register terminal 30 of the configuration of FIG. 2 of the above-described example embodiment.

The POS device 500 of the present example embodiment includes a product registering unit 502 and a product displaying unit 504.

The product registering unit 502 reads product identification information from a product and registers the product.

The product displaying unit 504 displays a product relating to a customer in a selectable manner, based on customer information generated by image-capturing the customer in front of a POS device itself (the POS device 500).

When a product displayed on the product displaying unit 504 is selected, the product registering unit 502 adds and registers the product.

Customer information generated by image-capturing a customer includes at least any one of, for example, an image, a feature value extracted from the image, or information of an age group, a gender, and a fashion of a customer identified from the image.

A product relating to a customer includes a product to be newly recommended to the customer and a product previously purchased by the customer.

A computer program according to an example embodiment of the present invention may be a program that causes at least one computer to execute a data processing method according to an example embodiment of the present invention to be described later or may be a computer-readable recording medium recording such a program. The recording medium include a non-transitory, tangible medium.

The computer program includes a computer program code that causes a computer to execute, when being executed by the computer, the data processing method on the POS device 500.

The computer program according to the example embodiment of the present invention is described in such a way as to cause a computer (any one or a combination of 50 and 80) to execute a step of registering a product by reading product identification information from the product, a step of displaying a product relating to a customer in a selectable manner, based on customer information generated by image-capturing the customer in front of a POS device itself, and a step of adding and registering, when the displayed product is selected, the product.

The computer program of the present example embodiment may be recorded on a computer-readable medium. The recording medium is not specifically limited and various forms are conceivable. Further, the program may be loaded on a memory of a computer from a recording medium or may be downloaded on a computer via a network and loaded on a memory.

A recording medium recording the computer program includes a non-transitory, tangible, computer-usable medium, and a computer-readable program code is embedded in the medium. When the computer program is executed on a computer, the computer is caused to execute a data processing method that achieves the POS device 500.

A data processing method of the POS device 500 of the present example embodiment configured in this manner is described below.

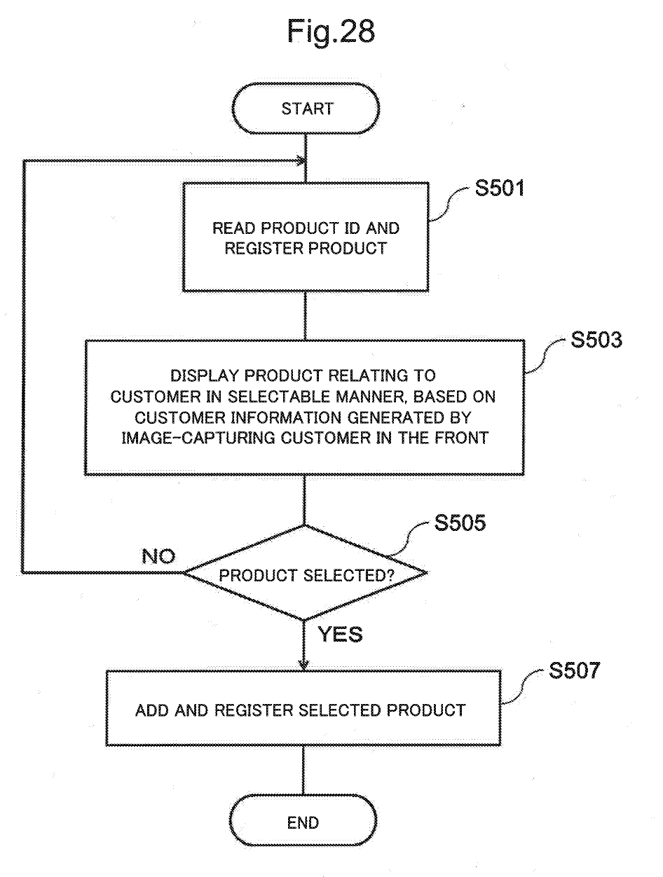

FIG. 28 is a flowchart illustrating one example of an operation of the POS device 500 of the present example embodiment.

A data processing method according to the example embodiment of the present invention is a data processing method for the POS device 500 and a data processing method executed by the computer 50 or the computer 80 that achieves the POS device 500.

The data processing method of the present example embodiment includes, by using the POS device 500, registering a product by reading product identification information from the product (step S501), displaying, based on customer information generated by image-capturing a customer in front of the POS device itself, a product relating to the customer in a selectable manner (step S503), and adding and registering, when the displayed product is selected (YES of step S505), the product (step S507).

For more details, first, a customer goes to the front of the register terminal 30 and passes a purchased product to a store clerk, and then the store clerk reads a bar code of the product by using the scanner 36 of the register terminal 30. The product registering unit 502 acquires a product ID converted from the bar code read by the scanner 36 and registers the acquired product ID in settlement information (step S501).

The product displaying unit 504 displays, based on customer information generated by image-capturing, using a camera 42, a customer in front of the register terminal 30, a product relating to the customer in a selectable manner, for example, the screen 130 of FIG. 9 on the customer display 34 (step S503). In the example of the screen 130, by executing a touch operation for an image of a product desired to be purchased by a customer, the product can be selected.

While a customer stands in front of the register terminal 30, an operation for a product image of the product image displaying unit 134 of the screen 130 displayed on the customer display 34 is accepted (step S505), a product ID of a product selected by an operation of the customer is notified to the product registering unit 502, and registration processing is executed by adding the product selected by the product registering unit 502 (step S507).

The present processing may be returned to step S503 and repeated until an operation for an “accounting” button of the touch panel of the store clerk display 32 of the register terminal 30 of FIG. 4 is executed by a store clerk. When the operation for the “accounting” button is accepted, product registration of a settlement target is terminated and settlement information is generated, similarly to the above-described example embodiments.

In the POS device 500 of the example embodiment of the present invention, a product relating to a customer is displayed by the product displaying unit 504 on the customer display 34, based on customer information generated by image-capturing the customer. When the customer selects the displayed product, a product selected by the product registering unit 502 is added and registered.

According to the POS device 500 of the present example embodiment, an appropriate product can be recommended according to customer information, for example, information of an age group, a gender, and a fashion. A product is selected according to customer information, for example, an attribute of a customer, and therefore it is highly possible to recommend a product suitable for a preference of the customer and a purchase intention of the customer can be effectively increased, resulting in sales promotion. In other words, it is possible to select an advertisement having a high advertising effect and display the selected advertisement on the customer display 34.

As described above, while example embodiments of the present invention have been described with reference to the accompanying drawings, these example embodiments are illustrative of the present invention, and various configurations other than the above can be employed.

While, for example, the selecting unit 108 is configured to select a product to be recommended to a customer according to attribute information of the customer, a product to be recommended to a customer may be selected by further using information of a product subjected to product registration processing by a product registering unit.

A product subjected to product registration, i.e. a product relating to a product being purchased by a customer may be selected. The database 120 may include product information such as a product frequently purchased (used) at the same time, a product of the same (a similar or serial) brand, the same (a similar or related) character product, an accessary (a cover, an option, or the like), an ingredient included in a recipe of the same dish, a color or material (discriminated by a natural, monochromatic, vivid color or the like), a product (e.g., an outdoor product, a sports product, and a hobby) having the same use situation, the same genre, the same (a similar) writer (maker, author, or artist), the same production area, and the like.

When a combination with an attribute of a customer is made, matching accuracy with a customer is increased and a recommendation effect is further expected. When, for example, a fashion of a customer is discriminated as outdoor clothes by image data and outdoor goods have been purchased, an outdoor product may be recommended to the customer.

Further, a configuration in which not only a product being currently purchased but also information of a product purchased in the past are considered is not excluded.

For example, a past product purchase history of a customer may be referred to from a member ID and used by a selecting unit during recommended product selection.

According to this configuration, it is possible that a product more suitable for a customer is recommended and sales promotion is achieved.

In another example embodiment, a configuration in which the image data generating unit 106 uses image data including a plurality of customers is conceivable.

When a plurality of customers is included, a case where a target is narrowed down to one person and a case where a recommended product is selected for each person are conceivable.

In the case where a target is narrowed down to one person, for example, a customer of a woman in an age group of her thirties to forties may be selected as a person who makes payment or a customer in a child's age who pesters his/her parent for purchase may be selected.

### EXAMPLES

As examples of the present example embodiment, a processing step relating to recommended product information display will be described using four different patterns as examples. In example 1, a pattern in which each piece of processing is started upon start of product registration processing as a trigger is described, and in example 2 to example 4, a pattern in which each piece of processing is started upon start of settlement processing as a trigger is described. Further, also in the case of regarding the start of product registration processing as a trigger, similarly to the case of settlement processing, a configuration in which selection processing for a recommended product or display processing for a recommended product is started is conceivable, but description thereof will be omitted.

### Example 1

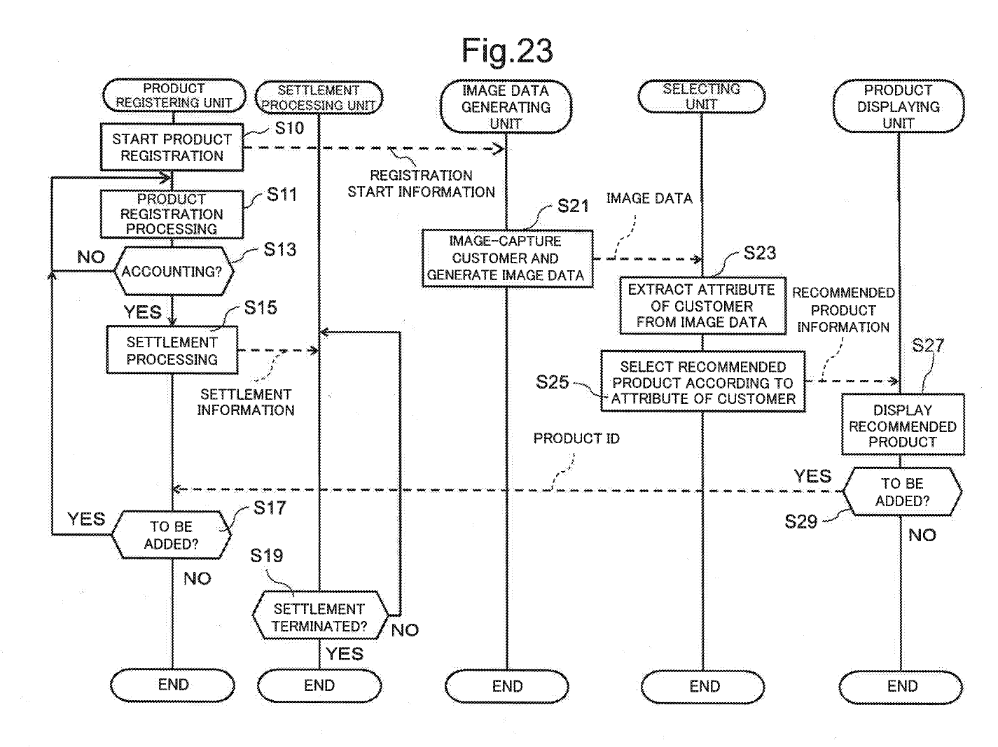

FIG. 23 is a flowchart illustrating one example of an operation of a settlement processing device 200 of the present example.

In the present example, generation processing for image data is started upon start of product registration processing as a trigger.

In a product registering unit 202, when product registration processing is started (step S10), registration start information is transmitted from the product registering unit 202 to an image data generating unit 106. The image data generating unit 106 starts to image-capture a customer and generates image data (step S21).

The product registering unit 202 concurrently executes product registration processing (step S11) for all the purchased products (NO of step S13), and by pressing an accounting button (YES of step S13) when registration of all the purchased products is finished, generates settlement information (step S15). The generated settlement information is transmitted to a settlement processing unit 104. The settlement processing unit 104 waits until an accounting procedure between a store clerk and a customer is terminated, determines, when, for example, a drawer 40 is closed, settlement termination (YES of step S19), and terminates the processing.

On the other hand, the generated image data are transmitted from the image data generating unit 106 to a selecting unit 108, and the selecting unit 108 extracts an attribute of the customer from the image data (step S23). The selecting unit 108 selects a recommended product according to the attribute of the customer (step S25). The selected recommended product information is transmitted from the selecting unit 108 to a product displaying unit 110, and the product displaying unit 110 displays a recommended product screen on a customer display 34 (step S27). When an additional operation for a product is executed by the customer (YES of step S29), a product ID is transmitted to the product registering unit 202.

When detecting the product addition (YES of step S17), the product registering unit 202 executes registration processing for the product (step S11). When pressing of the accounting button is accepted (YES of step S13), settlement information is regenerated (step S15), and the settlement information is retransmitted from the product registering unit 202 to the settlement processing unit 104.

After the settlement processing unit 104 executes settlement processing, based on the connection information (YES of step S19), the present processing is terminated.

### Example 2

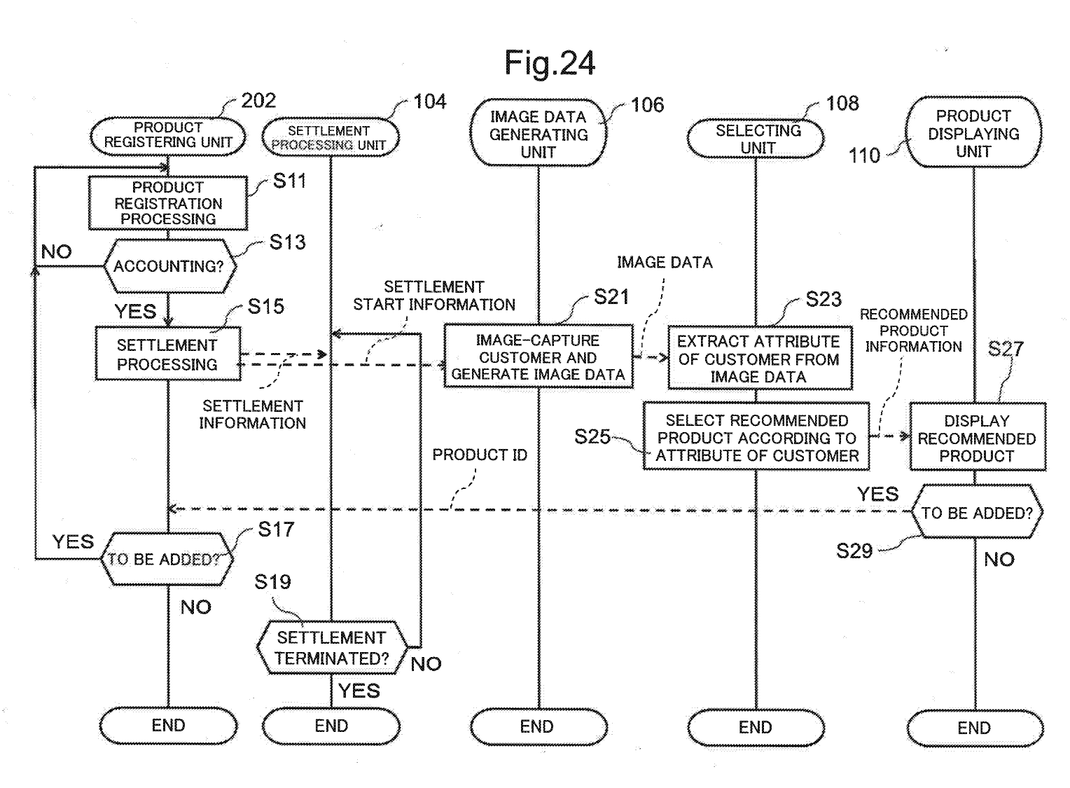

FIG. 24 is a flowchart illustrating one example of an operation of the settlement processing device 200 of the present example.

In the present example, generation processing for image data is started upon start of settlement processing as a trigger.

In a product registering unit 202, when product registration processing is executed (step S11), product registration processing is executed for all the purchased products (NO of step S13), and registration for all the purchased products is finished, by pressing an accounting button (YES of step S13), settlement information is generated (step S15).

The generated settlement information is transmitted to a settlement processing unit 104. The settlement processing unit 104 waits until an accounting procedure between a store clerk and a customer is terminated and determines, when, for example, a drawer 40 is closed, settlement termination (YES of step S19), and terminates the processing.

On the other hand, upon generation of settlement information in the product registering unit 202 or upon transmission of settlement information to the settlement processing unit 104, settlement start information is transmitted from the product registering unit 202 or the settlement processing unit 104 to an image data generating unit 106.

The image data generating unit 106 starts to image-capture a customer and generates image data (step S21).

The generated image data are transmitted from the image data generating unit 106 to a selecting unit 108, and the selecting unit 108 extracts an attribute of the customer from the image data (step S23). The selecting unit 108 selects a recommended product according to the attribute of the customer (step S25). Selected recommended product information is transmitted from the selecting unit 108 to a product displaying unit 110, and the product displaying unit 110 displays a recommended product screen on a customer display 34 (step S27). When an additional operation for a product is executed by the customer (YES of step S29), a product ID is transmitted to the product registering unit 202.

When detecting the product addition (YES of step S17), the product registering unit 202 executes registration processing for the product (step S11). When pressing of the accounting button is accepted (YES of step S13), settlement information is regenerated (step S15), and the settlement information is retransmitted from the product registering unit 202 to the settlement processing unit 104.

After the settlement processing unit 104 executes settlement processing, based on the connection information (YES of step S19), the present processing is terminated.

### Example 3

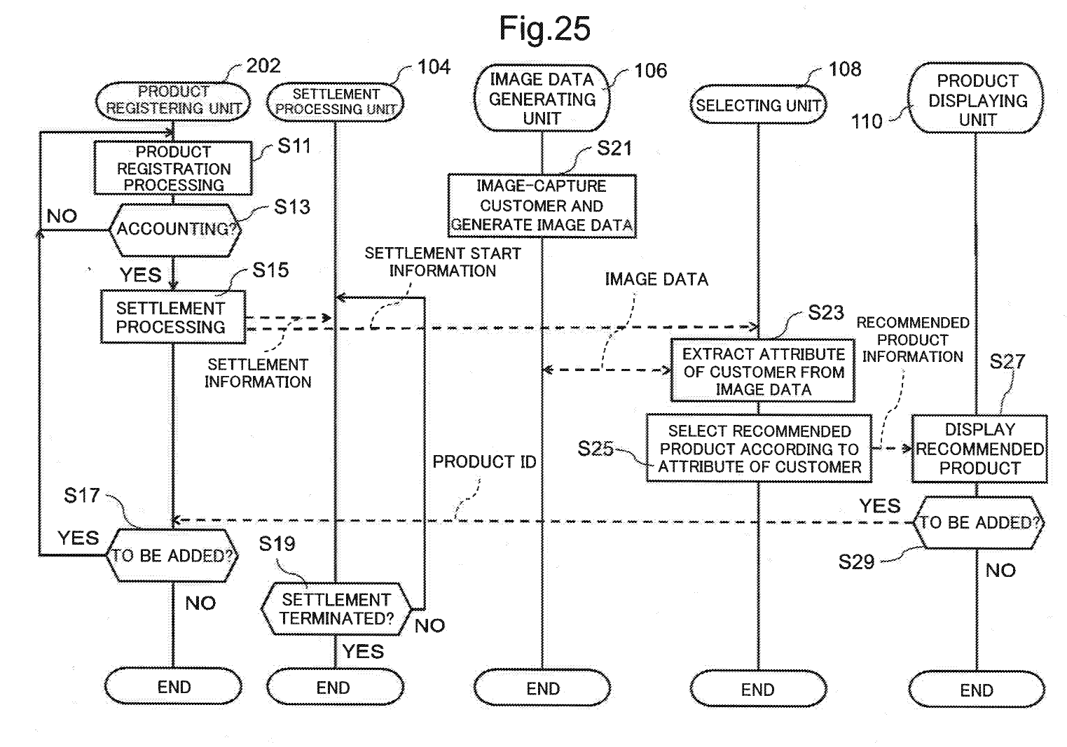

FIG. 25 is a flowchart illustrating one example of an operation of the settlement processing device 200 of the present example.

In the present example, generation processing of image data is executed before start of settlement processing, and selection processing for a recommended product is started upon start of settlement processing as a trigger.

An image data generating unit 106 image-captures a customer and generates image data (step S21). The generated image data are temporarily stored on a memory (e.g., the auxiliary storage device 63 of FIG. 6).

In a product registering unit 202, product registration processing is executed (step S11) and product registration processing is executed for all the purchased products (NO of step S13), and when registration of all the purchased products is finished, by pressing an accounting button (YES of step S13), settlement information is generated (step S15).

The generated settlement information is transmitted to a settlement processing unit 104. The settlement processing unit 104 waits until an accounting procedure between a store clerk and a customer is terminated, determines, when, for example, a drawer 40 is closed, settlement termination (YES of step S19), and terminates the processing.

On the other hand, upon generation of settlement information in the product registering unit 202 or upon transmission of settlement information to the settlement processing unit 104, settlement start information is transmitted from the product registering unit 202 or the settlement processing unit 104 to a selecting unit 108.

The selecting unit 108 acquires, when receiving the settlement start information, image data generated by the image data generating unit 106 and temporarily stored on a memory (e.g., the auxiliary storage device 63 of FIG. 6). The selecting unit 108 extracts an attribute of the customer from the image data (step S23). The selecting unit 108 selects a recommended product according to the attribute of the customer (step S25). Selected recommended product information is transmitted from the selecting unit 108 to a product displaying unit 110, and the product displaying unit 110 displays a recommended product screen on a customer display 34 (step S27). When an additional operation for a product is executed by the customer (YES of step S29), a product ID is transmitted to the product registering unit 202.

When detecting the product addition (YES of step S17), the product registering unit 202 executes registration processing for the product (step S11). When pressing of an accounting button is accepted (YES of step S13), settlement information is regenerated (step S15), and the settlement information is retransmitted from the product registering unit 202 to the settlement processing unit 104.

After the settlement processing unit 104 executes settlement processing, based on the connection information (YES of step S19), the present processing is terminated.

### Example 4

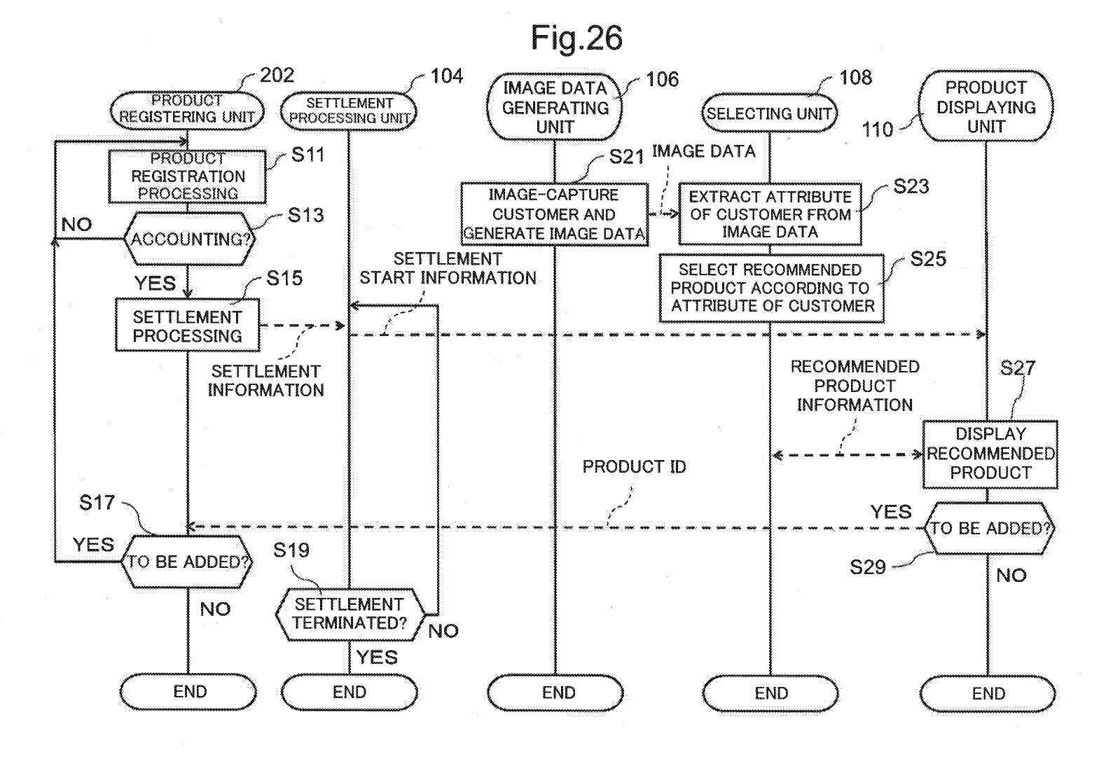

FIG. 26 is a flowchart illustrating one example of an operation of a settlement processing device 200 of the present example.

In the present example, before start of settlement processing, generation processing for image data and selection processing for recommendation display are executed, and display processing for a recommended product is started upon start of settlement processing as a trigger.

An image data generating unit 106 image-captures a customer and generates image data (step S21). The generated image data are transmitted from the image data generating unit 106 to a selecting unit 108, and the selecting unit 108 extracts an attribute of the customer from the image data (step S23). The selecting unit 108 selects a recommended product according to the attribute of the customer (step S25). Information of the selected recommended product is temporarily stored on a memory (e.g., the auxiliary storage device 63 of FIG. 6).

A product registering unit 202 concurrently executes product registration processing (step S11), executes product registration processing for all the purchased products (NO of step S13), and by pressing an accounting button (YES of step S13) when registration for all the purchased products is finished, generates settlement information (step S15).

The generated settlement information is transmitted to a settlement processing unit 104. The settlement processing unit 104 waits until an accounting procedure between a store clerk and a customer is terminated, determines, when, for example, a drawer 40 is closed, settlement termination (YES of step S19), and terminates the processing.

On the other hand, upon generation of settlement information in the product registering unit 202 or upon transmission of settlement information to the settlement processing unit 104, settlement start information is transmitted from the product registering unit 202 or the settlement processing unit 104 to a product displaying unit 110.

The product displaying unit 110 acquires, when receiving the settlement start information, information of a recommended product generated by the image data generating unit 106 and temporarily stored on a memory (e.g., the auxiliary storage device 63 of FIG. 6). The product displaying unit 110 displays a recommended product screen on a customer display 34 (step S27). When an additional operation for a product is executed by the customer (YES of step S29), a product ID is transmitted to the product registering unit 202.

When detecting the product addition (YES of step S17), the product registering unit 202 executes registration processing for the product (step S11). When pressing of an accounting button is accepted (YES of step S13), settlement information is regenerated (step S15), and the settlement information is retransmitted from the product registering unit 202 to the settlement processing unit 104.

After the settlement processing unit 104 executes settlement processing, based on the connection information (YES of step S19), the present processing is terminated.

While the present invention has been described with reference to example embodiments and examples thereof, the present invention is not limited to the example embodiments and examples. The constitution and details of the present invention can be subjected to various modifications which can be understood by those skilled in the art, without departing from the scope of the present invention.

It should be noted that when information regarding a user is acquired and used in the present invention, this is lawfully executed.

Hereinafter, examples of reference forms will be supplementarily noted.

1. A data processing method for a POS device,

the POS device

registering a product by reading product identification information from the product;

displaying, based on customer information generated by image-capturing a customer in front of the POS device itself, a product relating to the customer in a selectable manner; and

adding and registering the product when the displayed product is selected.

2. The data processing method for a POS device according to 1., wherein

the POS device

executes settlement processing for the registered product, and

displays, based on customer information generated by image-capturing a customer in front of the POS device itself, a product relating to the customer in a selectable manner after the settlement processing or the registration for the product is started.

3. The data processing method for a POS device according to 1. or 2., wherein

the POS device

displays a screen indicating a location of the selected product.

4. The data processing method for a POS device according to any one of 1. to 3., wherein

the POS device

displays an input screen for delivery processing for the product when the displayed product is selected by the customer.

5. The data processing method for a POS device according to any one of 1. to 4., wherein

the POS device

displays the product relating to the customer in a selectable manner by further using information of the registered product of the customer.

6. A program for causing a computer to execute:

a step of registering a product by reading product identification information from the product;

a step of displaying, based on customer information generated by image-capturing a customer in front of the POS device itself, a product relating to the customer in a selectable manner; and

a step of adding and registering the product when the displayed product is selected.

7. The program according to 6. for causing the computer to execute

a step of executing settlement processing for the product registered by the step of registering the product, and

a step of displaying, based on customer information generated by image-capturing a customer in front of the POS device itself, a product relating to the customer in a selectable manner after the step of executing the settlement processing or the step of registering the product is started.

8. The program according to 6. or 7. for causing the computer to execute a step of displaying a screen indicating a location of the selected product.
9. The program according to any one of 6. to 8. for causing the computer to execute a step of displaying an input screen for delivery processing for the product when the displayed product is selected by the customer.
10. The program according to any one of 6. to 9. for causing the computer to execute a step of displaying a product relating to the customer in a selectable manner by further using information of the registered product of the customer.
11. A POS system including:

an information processing device including a generating means configured to generate customer information by image-capturing a customer in front of a POS device; and

a POS device including
a product registering means configured to register a product by reading product identification information from the product, and
a first displaying means configured to display a product relating to the customer in a selectable manner, based on the customer information,
the product registering means adding and registering the product when the product displayed on the first displaying means is selected.
   12. The POS system according to 11., further including a settlement processing means configured to execute settlement processing for the product registered by the product registering means, wherein

the first displaying means

displays, based on customer information generated by image-capturing a customer in front of the POS device itself, a product relating to the customer in a selectable manner after the settlement processing by the settlement processing means or the product registration processing by the product registering means is started.

13. The POS system according to 11. or 12., further including a second displaying means configured to display a screen indicating a location of the selected product.
14. The POS system according to any one of 11. to 13., further including a third displaying means configured to display an input screen for delivery processing for the product when the product displayed on the first displaying means is selected by the customer.
15. The POS system according to any one of 11. to 14., wherein

the first displaying means

displays a product relating to the customer in a selectable manner by further using information of the product of the customer registered by the product registering means.

The present invention has been described using the above-described example embodiments as typical examples. However, the present invention is not limited to the above-described example embodiments. In other words, the present invention can be applied with various forms that can be understood by those skilled in the art, without departing from the scope of the present invention.

This application is based upon and claims the benefit of priority from Japanese patent application No. 2015-195351, filed on Sep. 30, 2015, the disclosure of which is incorporated herein in its entirety by reference.

### REFERENCE SIGNS LIST

1 Settlement processing system
3 Network
10 Server device
30 Register terminal
32 Store clerk display
34 Customer display
36 Scanner
38 Input button
40 Drawer
42 Camera
50 Computer
51 CPU
52 RAM
53 ROM
54 I/O
55 Display
56 Display control unit
57 Operating unit
58 Operation accepting unit
60 Camera
61 Microphone
62 Speaker
63 Auxiliary storage device
64 Bus
70 Program
80 Computer
82 CPU
84 Memory
85 Storage
86 I/O
87 Communication interface
89 Bus
90 Program
100 Settlement processing device
102 Product registering unit
104 Settlement processing unit
106 Image data generating unit
108 Selecting unit
110 Product displaying unit
120 Database
122 Correspondence table
124a Table
124b Product table
126 Correspondence table
130 Screen
132 Message displaying unit
134 Product image displaying unit
135 Product information displaying unit
136 Product detail information operating unit
138 Page operating unit
140 Screen
142 Message displaying unit
144 Product information displaying unit
145 Product image displaying unit
146 Purchase number selecting unit
148 Purchase operating unit
149 Cancellation operating unit
150 Settlement information
200 Settlement processing device
202 Product registering unit
210 Screen
212 First message displaying unit
214 Additional purchase product list displaying unit
215 Second message displaying unit
216 Third message displaying unit
217 Addition operating unit
218 Determination operating unit
219 Cancellation operating unit
300 Settlement processing device
302 Product location displaying unit
310 Screen
312 Layout displaying unit
313 Message displaying unit
314 Symbol explanation displaying unit
315 Checkout counter location displaying unit
316 Current location displaying unit
317 Product location displaying unit
318 Product location information displaying unit
400 Settlement processing device
402 Order screen displaying unit
404 Member information storage unit
406 Delivery list
408 Delivery destination information list
410 Screen
412 First message displaying unit
413 Ordered product information input unit
414 Delivery destination information input unit
415 Second message displaying unit
416 Order confirmation operating unit
417 Cancellation operating unit
420 Screen
422 First message displaying unit
423 Ordered product information displaying unit
424 Delivery destination information displaying unit
425 Second message displaying unit
426 Purchase operating unit
427 Change operating unit
428 Cancellation operating unit
500 POS device
502 Product registering unit
504 Product displaying unit

What is claimed is:

1. A POS device comprising:
a product register registering a product by reading product identification information from the product; and
a first display for displaying, based on customer information generated by image-capturing a customer in front of the POS device itself, a product relating to the customer in a selectable manner,
the product register adding and registering the product when the product displayed on the first display is selected.

2. The POS device according to claim 1, further comprising
a settlement processor for executing settlement processing for the product registered by the product register, wherein
the first display
displays, based on customer information generated by image-capturing the customer in front of the POS device itself, the product relating to the customer in a selectable manner after the settlement processing by the settlement processor or the product registration processing by the product register is started.

3. The POS device according to claim 1, further comprising
a second display for displaying a screen indicating a location of the selected product.

4. The POS device according to claim 1, further comprising
a third display for displaying an input screen for delivery processing for the product when the product displayed on the first display is selected by the customer.

5. The POS device according to claim 1, wherein
the first display
displays the product relating to the customer in a selectable manner by further using information of the product of the customer registered by the product register.

6. A POS system comprising:
an information processing device including a generator for generating customer information by image-capturing a customer in front of a POS device; and
a POS device including
a product register for registering a product by reading product identification information from the product, and
a first display for displaying a product relating to the customer in a selectable manner, based on the customer information,
the product register adding and registering the product when the product displayed on the first display is selected.

7. A data processing method for a POS device, the data processing method comprising:
by using the POS device,
registering a product by reading product identification information from the product;
displaying, based on customer information generated by image-capturing a customer in front of the POS device itself, a product relating to the customer in a selectable manner; and
adding and registering the product when the displayed product is selected.

8. (canceled)
